(19) United States
(12) Patent Application Publication
(10) Pub. No.: US 2014/0188583 A1
(43) Pub. Date: Jul. 3, 2014

(54) METHODS OF ALLOCATING BENEFITS DERIVED FROM ENERGY GENERATED WITHIN COMMUNITIES

(71) Applicant: Robert Thatcher, Lake Oswego, OR (US)

(72) Inventor: Robert Thatcher, Lake Oswego, OR (US)

(21) Appl. No.: 14/200,969

(22) Filed: Mar. 7, 2014

Related U.S. Application Data
(63) Continuation-in-part of application No. 13/719,086, filed on Dec. 18, 2012.
(60) Provisional application No. 61/774,401, filed on Mar. 7, 2013.

(51) Int. Cl. G06Q 30/02

(52) U.S. Cl. CPC G06Q 30/0208
USPC 705/14.11

(57) ABSTRACT

Methods of allocating benefits received in response to generating energy within a community to a community interest. The methods include deploying energy generating equipment on property of a host community member and receiving a benefit associated with purchasing the energy generating equipment or generating energy with the energy generating equipment. The methods further include estimating a benefit rate according to an expected generation value, the expected generation value defining an amount of energy expected to be generated by the energy generating equipment at a later time. Moreover, the methods include distributing at least a portion of the benefit to the community interest, the portion of the benefit distributed to the community interest calculated based on the benefit rate.

### CROSS REFERENCE TO RELATED APPLICATIONS

This application claims priority to copending U.S. application, Ser. No. 13/719,086, filed on Dec. 18, 2012, which is a non-provisional of U.S. Application, Ser. No. 61/581,455, filed on Dec. 29, 2011, and to copending U.S. provisional patent application No. 61774401, filed on Mar. 7, 2013, each application being hereby incorporated by reference for all purposes.

### BACKGROUND

The present disclosure relates generally to methods of allocating benefits. In particular, methods of allocating benefits derived from generating energy from renewable power sources within communities are described. In some examples, community power programs administer the transfer of benefits.

There are a variety of benefits that result from utilizing renewable energy as a source of power. The benefits include reduced pollution, reduced consumption of natural resources, and cost savings. The cost savings can be quantified and shared in the form of benefits, such as energy credits, beneficial tax treatment, or rebates.

Known methods of allocating benefits are not entirely satisfactory for the range of applications in which they are employed. For example, many known benefit allocation methods rely on power programs organized as Feed-In Tariffs or Solar Power Purchasing Agreements (“SPPAs”), or other similar programs.

Currently, SPPAs allocate benefits derived from using photovoltaic energy generating equipment to generate energy. More generally, SPPAs facilitate the deployment of renewable energy equipment. The SPPAs allocate a portion of the benefits among equipment providers and investors and allocate another portion of these benefits to consumers in the form price discounts for energy generated with renewable energy equipment.

While SPPAs provide financial structures or programs that make renewable energy equipment purchases more palatable to consumers, they clearly do not go far enough. For example, many communities do not develop plans to deploy renewable energy equipment despite the financial structures provided by SPPAs. Communities often fail to deploy renewable energy equipment in a significant way even when they have the means to do so and there are government mandates to generate a selected percentage of energy from renewable sources.

Existing programs often direct benefits accrued from using renewable energy generating equipment to the providers of the equipment and to parties financing the equipment to generate profits for the equipment providers and financers. However, the equipment providers and financers often bear little or no relation to the communities where the energy is being generated.

In some conventional methods of allocating benefits, a portion of the benefits derived from generating energy from renewable energy equipment installed on an individual's property is directed to the individual. Rather than directing a portion of the benefits to the property owner's community, the existing methods allocate benefits exclusively to the individual property owner, to the equipment provider, or to the equipment financers.

By failing to account for the community's interests, the conventional benefit allocation methods create an unbalanced value proposition to consumers in the community. The unbalanced value proposition hinders renewable energy development in the community. By providing little or no benefit to communities as a whole, conventional methods for allocating benefits associated with utilizing renewable energy equipment often do not adequately incentivize communities to deploy renewable energy equipment.

As a result, there exists a need for benefit allocation methods that balance the value proposition to include communities by providing benefits to the communities. With a solution to incentivize communities as a whole to adopt renewable energy equipment, more renewable energy equipment will be deployed and more renewable energy will be utilized. Utilizing more renewable energy is good for the planet and good for consumers.

### SUMMARY

The present disclosure is directed to methods of allocating benefits received in response to generating energy within a community to a community interest. The methods include deploying energy generating equipment on property of a host community member and receiving a benefit associated with purchasing the energy generating equipment or generating energy with the energy generating equipment. The methods further include estimating a benefit rate according to an expected generation value, the expected generation value defining an amount of energy expected to be generated by the energy generating equipment at a later time. Moreover, the methods include distributing at least a portion of the benefit to the community interest, the portion of the benefit distributed to the community interest calculated based on the benefit rate.

### BRIEF DESCRIPTION OF THE DRAWINGS

FIG. 1 is a flow diagram illustrating relationships among parties of a first example of a community power program.

FIG. 2 is a flow diagram illustrating a first example of a method for allocating benefits from energy generated within a community to a community interest.

FIG. 3 is a schematic view showing relationships among a portion of the parties in the community power program shown in FIG. 1.

FIG. 4 is an illustration of an example of a statement from a solar provider illustrating an example of a community power program participation entry.

FIG. 5 is a flow diagram illustrating relationships among parties of a second example of a community power program.

FIG. 6 illustrates an organizational scheme for a third example of a community power program.

FIG. 7 illustrates an example of a statement from an example utility participating in a community power program.

FIG. 8 is a schematic view of an example of a programmable computing device for carrying out electronic metering, communication, and user-interactive features of disclosed community power programs.

FIG. 9 is a flow diagram illustrating relationships among parties of a third example of a community power program.

FIG. 10 is a flow diagram illustrating another example of a method for allocating benefits from energy generated within a community to a community interest.

FIG. 11 is a schematic view showing relationships among selected parties in the community power program.

FIG. 12 is an example of a community display of community energy generation metrics.

FIG. 13 is a schematic view of a community depicting participation levels in different regions of the community.

FIG. 14 is a flow diagram of a method for displaying information related to energy generated by a community.

### DETAILED DESCRIPTION

The disclosed methods of allocating benefits will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods of allocating benefits are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

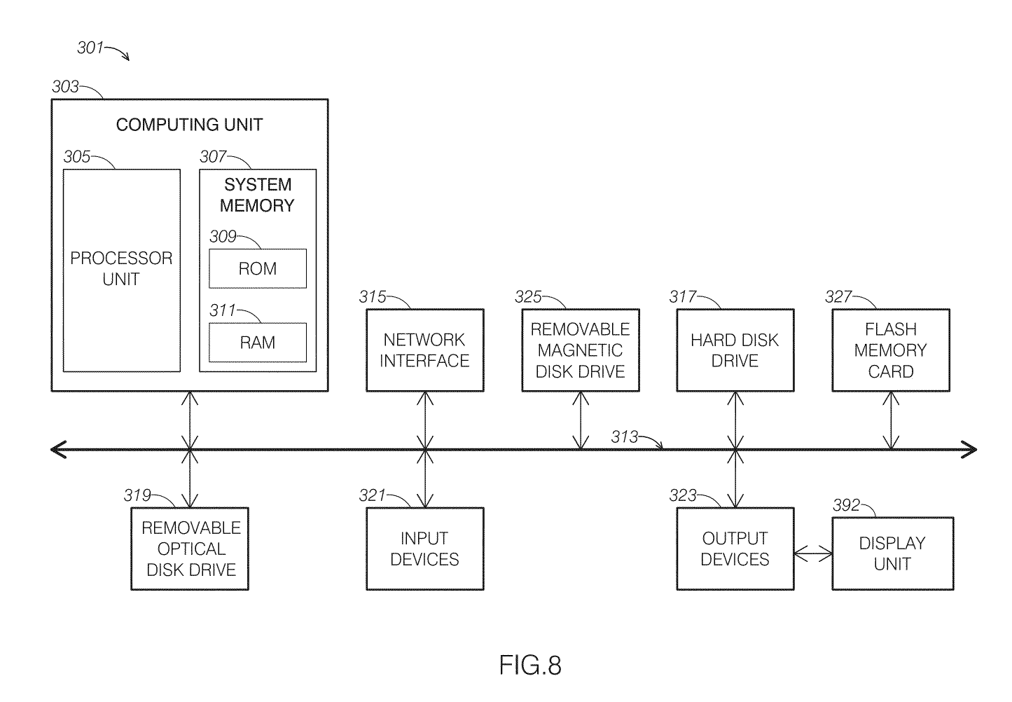

Accordingly, FIG. 8 shows one illustrative example of a computer 301 that can be used to implement various embodiments of the invention. Computer 301 may be incorporated within a variety of consumer electronic devices, such as personal media players, cellular phones, smart phones, personal data assistants, global positioning system devices, and the like.

As seen in this figure, computer 301 has a computing unit 303. Computing unit 303 typically includes a processing unit 305 and a system memory 307. Processing unit 305 may be any type of processing device for executing software instructions, but will conventionally be a microprocessor device. System memory 307 may include both a read-only memory (ROM) 309 and a random access memory (RAM) 311. As will be appreciated by those of ordinary skill in the art, both read-only memory (ROM) 309 and random access memory (RAM) 311 may store software instructions to be executed by processing unit 305.

Processing unit 305 and system memory 307 are connected, either directly or indirectly, through a bus 313 or alternate communication structure to one or more peripheral devices. For example, processing unit 305 or system memory 307 may be directly or indirectly connected to additional memory storage, such as a hard disk drive 317, a removable optical disk drive 319, a removable magnetic disk drive 325, and a flash memory card 327. Processing unit 305 and system memory 307 also may be directly or indirectly connected to one or more input devices 321 and one or more output devices 323. Input devices 321 may include, for example, a keyboard, touch screen, a remote control pad, a pointing device (such as a mouse, touchpad, stylus, trackball, or joystick), a scanner, a camera or a microphone. Output devices 323 may include, for example, a monitor display, an integrated display, television, printer, stereo, or speakers.

Still further, computing unit 303 will be directly or indirectly connected to one or more network interfaces 315 for communicating with a network. This type of network interface 315, also sometimes referred to as a network adapter or network interface card (NIC), translates data and control signals from computing unit 303 into network messages according to one or more communication protocols, such as the Transmission Control Protocol (TCIP), the Internet Protocol (II), and the User Datagram Protocol (UDP). These protocols are well known in the art, and thus will not be discussed here in more detail. An interface 315 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 301 may be connected to a digital music player, such as an IPOD® brand digital music player or iOS or Android based smartphone. As known in the art, this type of digital music player can serve as both an output device for a computer (e.g., outputting music from a sound file or pictures from an image tile) and a storage device.

In addition to a digital music player, computer 301 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 301 so that their data maintained may be synchronized.

Of course, still other peripheral devices may be included with or otherwise connected to a computer 301 of the type illustrated in FIG. 8, as is well known in the art. In some cases, a peripheral device may be permanently or semi-permanently connected to computing unit 303. For example, with many computers, computing unit 303, hard disk drive 317, removable optical disk drive 319 and a display are semi-permanently encased in a single housing.

Still other peripheral devices may be removably connected to computer 301, however. Computer 301 may include, for example, one or more communication ports through which a peripheral device can be connected to computing unit 303 (either directly or indirectly through bus 313). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 301 may include a wireless data “port,” such as a Bluetooth® interface, a Wi-Fi interface, an infrared data port, or the like.

It should be appreciated that a computing device employed according various examples of the invention may include more components than computer 301 illustrated in FIG. 8, fewer components than computer 301, or a different combination of components than computer 301. Some implementations of the invention, for example, may employ one or more computing devices that are intended to have a very specific functionality, such as a digital music player or server computer. These computing devices may thus omit unnecessary peripherals, such as the network interface 315, removable optical disk drive 319, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

This disclosure is directed to methods of allocating benefits derived from generating energy from selected power sources, such as renewable or alternative energy sources. The selected power sources may be developed, deployed, or otherwise facilitated by community power programs. The community power programs may additionally or alternatively manage the benefits deriving from the community utilizing the selected power source and use the methods described herein to allocate those benefits to the various stakeholders.

The selected power sources may be energy source that is advantageous to utilize for a given situation or application. Renewable or alternative energy sources will often be advantageous and thus this disclosure will refer to renewable energy sources as the selected energy source. Renewable and alternative power sources include solar power systems, fuel cell systems, wind power systems, wave power systems, hydropower systems, ethanol systems, algae systems, and the like.

However, other energy sources, such as wind or fuel cells installed on the premises of consumers may be a selected energy source and advantageous for a given application. The advantages of a given power source may be based on the power source's availability, cost, convenience, effectiveness, or efficiency, among other attributes.

The methods described herein allocate benefits to community interests or to community interest organizations. Allocating benefits to community interests provides incentives for communities to utilize selected energy sources, such as renewable energy sources. The disclosed methods address the lack of community incentives that exist in conventional approaches that provide incentives only to individuals, to renewable energy equipment providers, or to renewable energy infrastructure financers.

In some examples, members of the community host renewable energy generating equipment, such as solar panels, on their property. The renewable energy generating equipment generates energy in a way that is beneficial as compared to other energy sources. For example, the energy may be generated with less expense, less pollution, and/or less consumption of natural resources.

The benefits of generating energy via the renewable energy generating equipment may be quantified in some manner as a benefit. The benefits may be reflected in energy credits, beneficial tax treatment, or rebates. In some examples, the benefits reflect the amount of energy generated with the renewable energy equipment.

The benefits described herein, such as energy credits, savings realized, or a portion of the value of actual energy produced, may be transferred to other parties in some instances. Transferring the benefits can be thought of, in effect, as transferring the power generated by equipment hosted by one party to another party. Importantly, the benefits can be transferred in a way to selected to provide incentives and to increase the overall utility of a selected power source to a community at large.

According to the methods described herein, a community power program may direct a portion of the benefits derived from a community member generating renewable power or hosting renewable energy equipment on his property to the community itself. Community power programs may direct these benefits to community interests, community interest organizations, or separate receiver entities. As described above, community power programs may, in effect, provide community interests with energy by directing energy credits or the value of the energy to them to offset their costs to obtain energy from other energy sources.

In some examples, hosts or communities enter SPPAs with renewable energy providers, utilities, or special purpose entities. In these SPPAs, the hosts or communities enter into an agreement to pay for their use of renewable energy generated by renewable energy generating equipment at a price that is discounted to reflect the benefits received for producing the renewable energy. In many cases, the hosts receive their share of the energy generated in the form of energy credits or what is referred to as net metering, which is applied to their energy bill. In such examples, the hosts often consume substantially all of their energy from the existing power grid infrastructure and apply the energy credits they earn to their resulting energy bill.

Unlike many existing SPPAs, however, the disclosed methods may direct benefits, such as energy credits earned by parties hosting renewable energy equipment, to community interests. The benefits may be directed to community interests via community interest organizations or separate receiver entities organized to distribute the benefits to community interests. In many cases, the community members in aggregate provide, in effect, all the energy the community interest needs by allowing a solar provider to donate a portion of the community members' solar payment to the community interest.

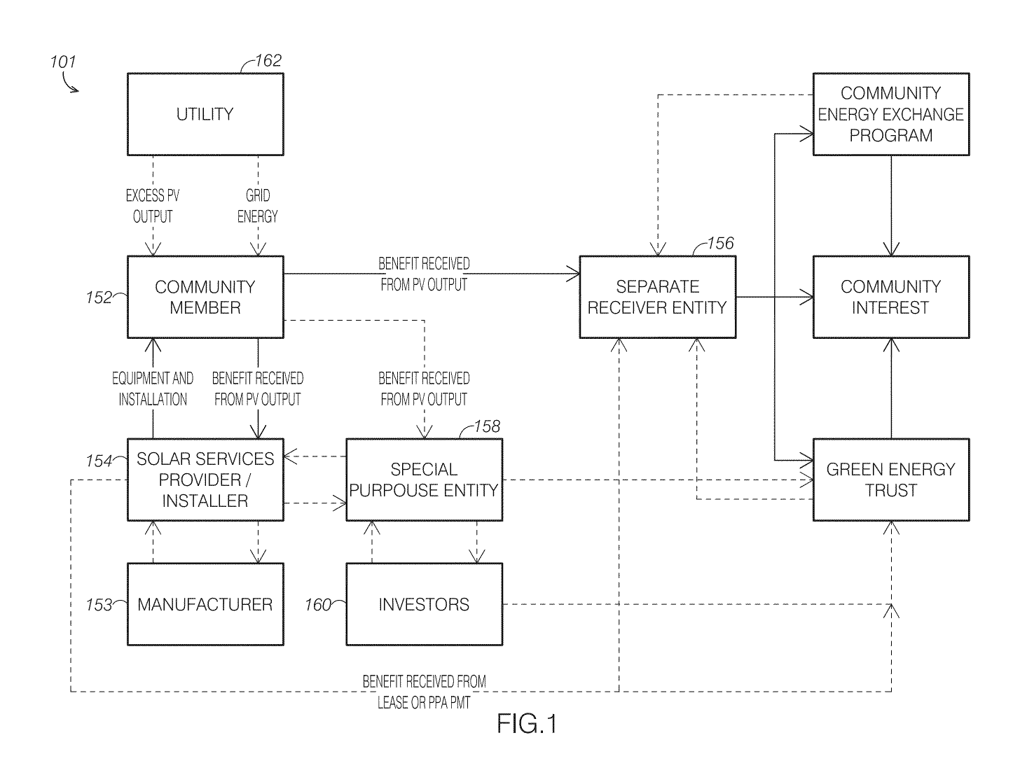

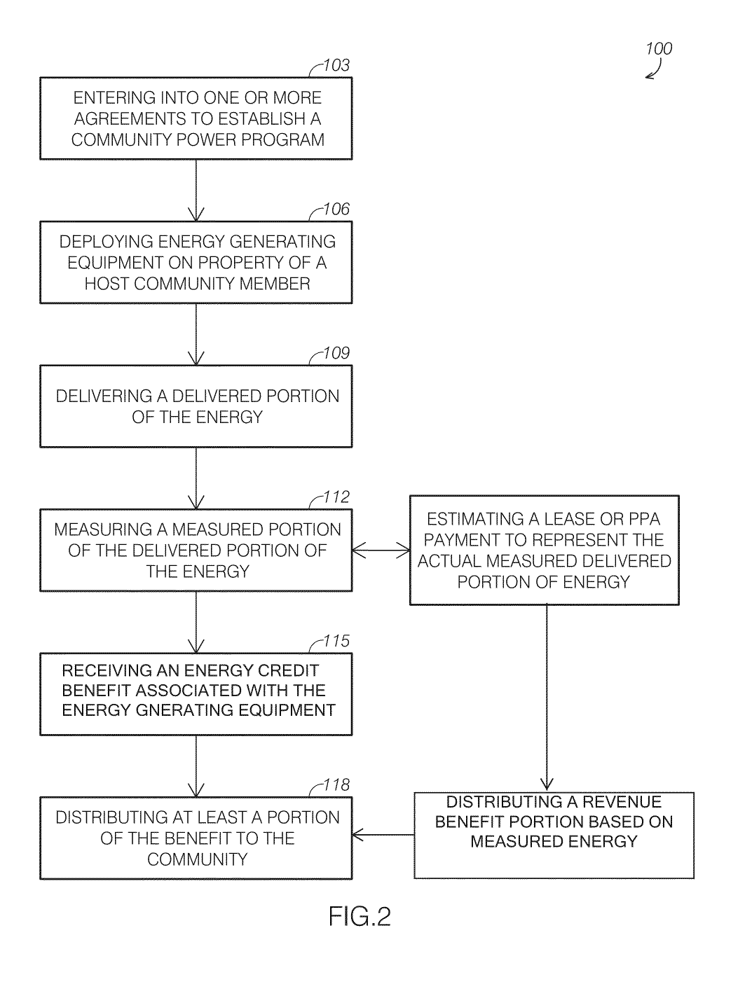

With reference to FIGS. 1-4, a first example of a method of allocating benefits deriving from energy generated within a community, method 100, will now be described. As FIG. 2 illustrates, method 100 includes entering into one or more agreements to establish a community power program at step 103, deploying energy generating equipment on property of a community member at step 106, delivering a delivered portion of the energy at step 109, measuring a measured portion of the delivered portion of the energy at step 112, receiving a benefit associated with the energy generating equipment at step 115, and distributing at least a portion of the benefit to the community at step 118. Method 100 and other associated examples are discussed with reference to many features that are not necessary in each and every community power program or method implementing the same.

A variety of communities with different community members can benefit from the methods described herein. No specific communities are identified, but the example communities typically include a group of community members that share a common interest. In some examples, communities may be defined by geographic proximity, such as a neighborhoods or geographic areas. Similarly, communities may be defined by governmental designations, such as cities, towns, counties, states, school districts, etc.

Some examples of communities, however, are defined solely or partially by a shared interest of the community members. For example, certain communities define interest groups with members from disparate locations; however, each member shares a common community interest. These interest groups may support charitable causes or public development. In some examples, communities define residences within a school district with one or more local schools.

Community with members in geographic proximity to one another may provide some unique benefits. Some communities may include members that lack sufficient space and exposure to sunlight on their property to generate solar power with solar power equipment. As a result, several community members may have inadequate means to take advantage of the benefits associated with installing and using renewable energy generating equipment though they are otherwise willing and interested in doing so.

Because community power/revenue programs direct a portion of benefits associated with community-generated renewable energy to community interests, community power/revenue programs provide incentives for communities at large, including the non-generating members. This may lead non-generating members to spur renewable energy development in their community, even when unable to generate renewable energy themselves. The non-generating members may spur development by convincing neighbors to host energy generating equipment on their property or by developing community organizations directed to renewable energy development in their community.

The disclosed methods may direct benefits derived from community members generating energy with renewable energy equipment, such as photovoltaic panels or wind turbines, to community interests and community interest organizations. As previously discussed, these benefits may include energy credits. As will be discussed below, the benefits may further include other benefits beyond energy credits.

Because the benefits deriving from generating renewable energy may be donated through community power programs, community power programs may be particularly adapted to developing renewable and alternative energy programs within communities. In some instances, community members can install and use renewable energy equipment without the considerable regulatory hurdles that often apply to larger entities when they seek to deploy renewable energy equipment. Avoiding some of the regulatory hurdles to deploy renewable energy equipment makes community power programs even more adaptable to renewable and alternative energy programs.

Private entities seeking to deploy renewable energy equipment sometimes find it difficult to locate or afford the space necessary to install renewable energy equipment. However, a community and its members may have property available to host renewable and alternative energy generating equipment, thereby making available space to install equipment and facilitating renewable energy projects Further, a community and its members may have underutilized property; community power programs may adjust incentives encourage community members to develop such underutilized property.

Directing benefits to community interests may produce tangible benefits within the community. For example, benefits directed to a school district or member schools may allow the schools to reduce their energy expenditures. Additionally or alternatively, directing benefits to schools may develop or support after-school programs and other school sponsored activities.

By directing benefits deriving from generating renewable energy on community properties to interests that benefit the community as a whole, community power programs are able to change the value proposition of renewable energy programs while often preserving many of the property owners' individual benefits, such as discounted energy costs. For example, many conventional methods allocate benefits primarily to drive investors' profits.

Allocating benefits primarily to investors insufficiently incentivizes communities to collectively develop renewable energy projects. Providing stronger incentives to communities will drive them to be more willing to develop renewable energy projects, such as solar energy projects. These programs may even tilt the incentives to a tipping point where renewable energy projects become so economical as to be preferred as a mainstream alternative to non-renewable or high polluting energy sources. In some instances, renewable energy generating equipment is deployed on property owned by one or more supplemental host community members in response to directing a portion of the resulting benefits to a community interest or to a community interest organization.

Directing a portion of the benefits to community interests or community interest organizations may lead to greater installation density within associated communities. This would, in turn, drive heavy investment into local grid infrastructure, such as “smart-grid” technologies that increase the efficiency with which energy is locally distributed. Additionally or alternatively, increased installation density may make installing local energy storage, such as batteries, both practical and commercially viable. At present, the low-density, scattered distribution of renewable energy installations coupled with the low number of installations requires storage capacities and charge retentions that current battery technologies are currently unable to provide. Increasing the density and number of installations would reduce the importance of the current limitations of battery technologies.

In some examples, a special purpose entity or host may share revenue with a utility to help mitigate the losses experienced when forced to buy solar power at a higher rate than the power can be resold. Revenue sharing in this fashion may, in some examples, operate similar to contemporary Feed-in-Tariff systems. Many Feed-in-Tariff systems, however, run in to problems resulting from utilities being forced to purchase energy from hosts of energy generating equipment (or managing special purpose entities) at rates higher than they can resell the energy.

The methods described herein, however, may improve upon contemporary Feed-in-Tariff systems by including a surcharge on the cost of energy generating equipment. The surcharge may represent an amount beyond the operating costs of a special purpose entity or other managing entity. The special purpose entity may share a portion of its revenue, such as revenue beyond its operating expenses, to a utility to offset any losses incurred by the utility. Because of the revenue sharing features of the methods described herein, utilities and/or special purpose entities may be more apt to use the Feed-in-Tariff framework to help subsidize and proliferate renewable energy generating equipment within a community.

As FIG. 2 illustrates, one or more agreements are entered into to establish the community power program at step 103. In some examples, the agreements may collectively define a SPPA among several parties. FIG. 1 illustrates an example of a community power program, program 101, which includes some features that are similar or identical to conventional SPPAs. Program 101 includes a host community member contracting with a solar provider. In the contract, the solar provider agrees to deploy solar equipment on the community member's property in exchange for the community member purchasing energy generated by the solar generating equipment from the solar provider.

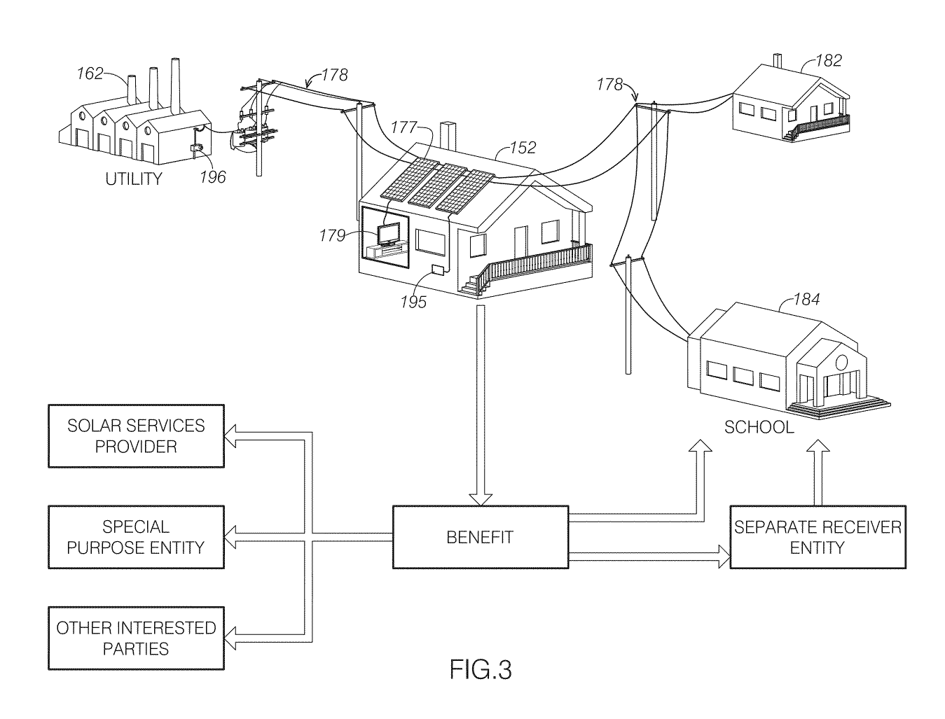

As FIG. 1, shows, parties to community power/revenue program 101 may include a host community member 152, a solar services provider 154, a separate receiver entity 156, a special purpose entity 158, energy equipment providers 153 (which may include manufacturers and installers), investors 160, and a utility 162. Although FIGS. 1 and 3 illustrate a single host community member, community power programs may additionally or alternatively include one or more supplemental host community members. The special purpose entity (SPE) governs the various parties' relationships and dictates the financial structure relating to the hosts' energy generation. The SPE can govern the flow of capital, revenue, profits, and other benefits (such as energy credits and favorable tax treatment).

Community power programs do not necessarily need to include an SPE similar to the one shown in FIG. 1. For clarity's sake, however, the foregoing discussion will discuss examples of community power programs that are partially governed by an SPE similar to the one illustrated in FIG. 1. In some examples, additional or alternative agreements may also govern the parties' interests.

No agreement must be formal, nor does it need to be in writing. There is no requirement for any party to contract with any other specific party.

As FIG. 2 shows, energy generating equipment is deployed on property of a host community member at step 106. In some examples, the host community member may receive energy credits in exchange for generating energy on her property, which the host community member may donate to a community interest through a community power/revenue program. In some examples, the energy generating equipment may be of a type that accrues additional or alternative benefits. For example, the energy generating equipment may be renewable energy generating equipment, such as photovoltaic cells or wind turbines, and generate credits or favorable tax treatment.

FIG. 3 diagrammatically illustrates an example where a host community member, host community member 152, has installed energy generating equipment 177 on his property. In the present example, community member 152 has installed photovoltaic panels on the roof of his residence. Installing energy generating equipment 177 yields benefits to community member 152.

As discussed above, installing renewable and/or low-pollution energy generating equipment, such as solar panels or wind farms, often yield rebates, credits, favorable tax treatment, payments, or other benefits. In some cases, the benefits are provided in exchange for generating renewable energy, such as on a per-unit of energy generated basis. In other cases, the benefits are provided upon purchasing or installing the equipment.

The host community members may be local businesses or property owners with a large amount of area in which to install energy generating equipment. For example, businesses may have large surface areas exposed to the sky, such as parking lots or roofs of retail buildings or warehouses, that residential community members may not have available. In addition to the appeal of directing benefits to community interests, businesses may market themselves for their participation in the program. The opportunity to market their participation in a community power program may entice additional businesses to operate within the community as part of the community power program.

As FIG. 3 illustrates, host community member 152 is electrically connected to a power grid 178. Power grid 178 connects host community member 152 to utility 162; to other community members, such as receiving community member 182; and to community interest properties 184, such as schools, churches, and government buildings.

As FIG. 3 shows, host community member 152 may direct energy to power grid 178. In many such cases, host community member 152 may be compensated by utility 162 for directing energy to the power grid. The host community member's output may be metered, and another party, such as a utility or governmental entity, may provide the host community member with benefits in exchange for the generated energy. In some instances, the host community member may direct all of the energy generated by his energy generating equipment to the power grid.

The host community member may be recompensed for hosting the energy generating equipment and for generating energy in a number of ways. In some examples, the host community member may not be charged for the energy generating equipment. Additionally or alternatively, the host community member may receive energy from the grid at a reduced price or for free.

The reduced cost may reflect the impact of benefits from parties other than the host community member. The other parties may receive their benefits in exchange for generating energy with energy generating equipment, such as renewable energy generating equipment. The benefits received by the other party may be subsidies, tax credits or deductions.

As discussed more below, community power/revenue programs may capture at least a portion the benefits received by community members and direct them to a community interest. In some examples, the community power program may direct benefits to the community as a whole through special purpose entities or separate receiver entities. Special purpose entities and separate receiver entities are entities organized to hold benefits and/or distribute them to community interests.

For example, when energy credits, beneficial tax treatment, or other such benefits, are generated in response to generating energy using the energy generating equipment, the special purpose entity or separate receiver entity may direct the benefits to community interests to discount or eliminate their power expenditures. In effect, the benefits accrued by one or more host community members are used to power community interests.

For example, a host community member may receive energy at a discounted price that reflects benefits, such as energy credits or beneficial tax treatment, accrued by another party. In some examples, the price discount may be applied to the power consumed by a community interest rather than to the power consumed by a host community member. In effect, the host community member supplies some or all of the power needed by a community interest organization. Additionally or alternatively, the host community member may supply power to the community interest organization in a more literal sense: unused portions of the actual energy generated by the energy generating equipment on the community member's property may be directed, either through a direct line or through a power grid, to the community interest organization.

In the example shown in FIG. 3, while perhaps atypical conventionally, host community member 152 uses energy generating equipment 177 to generate electricity for at least a portion of his own electricity requirements. As illustrated in FIG. 3, host community member 152 uses energy generating equipment 177 to generate energy sufficient to power electrical device 179. At present, it is not common for a community power program to accommodate a host community member using a portion of the energy generated with energy generating equipment to power the host community member's onsite electric loads, but such arrangements are within the scope of the methods described herein.

Because of the complexities of the power grid, the benefits may appear as reduced energy consumption costs on an organization's balance sheet or power bill. The shifting of benefits, however, does, in effect, provide power to community interests. In many cases, the power generated by host community members (or other credits and other vehicles designed to capture the environmental benefit of their equipment) is directed to community interests. This, in effect, allows host community members to collectively power those community interest organizations, even if this effect is obfuscated due to the complexity of power distribution. In any respect, the transfer of energy credits operates as a de facto transfer of energy to a recipient through the power grid.

Abstracting the transfer of energy is often helpful due to the inherent limitations of a power grid. For example, when energy is directed to a power grid, it is very difficult (and often impossible) to ensure a host community member's generated electricity reaches a particular destination. Rather than attempting to tediously track the transfer of a particular quantity of energy, “credits” or equivalent monetary value of credits or other accounting tools that reflect a party's input and/or output relative the grid may be exchanged instead. As a result, the methods described herein provide a way for community members to, in effect, supply power to community interest organizations even if the host-generated electricity does not necessarily physically travel to a particular community interest organization.

In some cases, utility 162 may perform metering (according to many known metering techniques, such as net metering) to determine the amount of energy generated by a host community member. Metering can be accomplished with standard metering equipment. As will be discussed in greater detail below, the metering equipment may include a computing system with one or more computing features that are substantially similar to features of computer 301 described above. The computing features may increase the efficiency and effectiveness of the metering equipment and correspondingly increase the effectiveness of the disclosed methods.

Parties to community power/revenue programs may accrue net metering credits and/or energy share credits based on metered energy use. Utility 162 may measure various parameters related to the amount of energy generated by energy generating equipment 177. One parameter may be all of the energy generated by the energy generating equipment hosted by a community member. Another parameter may be the difference between the energy generated by the energy generating equipment and the amount of grid energy used by the community member hosting the energy generating equipment. Another parameter may be the amount of energy the community member directed to the power grid.

As FIG. 3 illustrates, a host community member may have a meter, such as meter 195, installed on his property that tracks the amount of energy generated by energy generating equipment 177 hosted on his property. In other examples, the amount of energy generated with the energy generating equipment may be tracked by a meter at a utility, such as meter 196.

The amount of energy generated by the energy generating equipment may be tracked by smart grid technologies. Meter 195 and meter 196 include computer features provided by computer hardware, such as computer 301, to display or communicate data related to energy generated by energy generating equipment. The computer hardware may communicate with utilities, solar power providers, or special purpose entities to share data for determining the amount of benefits to direct to community interests.

In some examples, host community members may use additional or alternative computers in the home to communicate with meter 195, with meter 196, or with a utility over a computer network. Data communicated may include energy generation and consumption statistics and participation levels in a community power program. In some examples, the community member may additionally or alternatively receive statistics about his neighbors' generation and/or consumption and level of participation in a community power program. Energy and participation information related to one's peers may drive competition among community members.

In some example, utilities may provide benefits to host community member 152 (or another party in the community power program, on behalf of host community member 152) in exchange for host community member 152 generating renewable energy. Additionally or alternatively, utilities may receive benefits as a result of host community member 152 generating renewable energy. In some examples, utilities may direct benefits to other entities, such as separate receiver entities or special purpose entities, to efficiently distribute benefits to community interests.

Metering devices used to measure energy in various examples are often in data communication with a utility or other entity, and may communicate results to those entities. Parties within the community power program may receive benefits in exchange for these communicated results. Any such benefits that are allocated based on metering techniques may be directed to a community interest.

In some examples, the metering system may be connected to a computing system, such as one similar to computer 301, that may display, manipulate, and communicate metered results. In some examples, the computing system may communicate the metered results to the utility or the special purpose entity to determine the quantity of energy or benefits to transfer to a community interest according to the community power/revenue program. In some examples, the computing system (or the meter itself) may be able to display on a display unit the amount of benefits accrued and/or transferred to the community interest on behalf of the host community member.

In other examples, the amount of benefits accrued and/or transferred to the community interest on behalf of the host community member may be communicated to a public location or other community accessible location. For instance, the amount of benefits may be communicated by hosting the data on a publicly accessible or community accessible web server for the community to access the data. Publishing the amount of benefits accrued may drive competition among community members. This competition may increase the amount of renewable energy generated within communities. Competition may additionally or alternatively increase the amount of benefits directed to community interests.

In some examples, the metering results may be directed to other entities that provide benefits for generating renewable energy, such as governmental entities and private interest groups. In some examples, utilities and/or government entities may provide operating grants, surcharges, or tariffs that support the community power program.

As FIG. 1 illustrates, host community members often work with other parties to make installing energy generating equipment quicker, easier, and more economical. For example, host community member 152 may contract with solar services provider 154 to coordinate financing, design, and construction of the energy generating equipment on his property. In some examples, solar services provider 154 may coordinate with energy equipment providers 153, such as manufacturers, installers, or services technicians.

In some examples, the solar service providers may integrate with manufacturers and installers to perform all of the services relating to the installation of energy generating equipment. Synergistic integration may produce economic benefits, which can be directed to community interests. Solar services providers may, in some examples, be managed and operated by a utility, manufacturer, one or more investors, a special purpose entity, or other parties discussed above.

As FIG. 1 illustrates, community power/revenue program 101 includes special purpose entity 158 organized to perform various financial and managerial duties associated with the community power program. These duties may include partially funding the deploying energy generating equipment on the property of the community member. The duties may include directing funds from investors or tranche funds to develop new renewable energy projects.

In some examples, special purpose entities may use benefits received in association with existing renewable energy developments to fund new ones. A special purpose entity may negotiate prices with manufacturers, provide financing arrangements, and manage the interests of investors, such as by providing them with investment structures to invest in community power programs. The investment structure may include equity shares in the special purpose entity or an associated separate receiver entity. Special purpose entities may also offer investors a promise to share a percentage of gains they accumulate.

In some examples, the special purpose entity (or other parties that interface with investors, manufacturers, and/or installers) may set financing arrangements. Financing arrangements may include a tax equity fund that provides financing for the energy generating equipment. This fund may provide preferential tax treatment, which generates a benefit that may be directed to the community interest.

In some examples, special purpose entities may provide investment vehicles that attach solar output ratings to associated community members. Solar performance ratings are calculated to numerically express a community member's ability to produce solar power. This solar rating may be useful to determine how to allocate solar energy generating equipment among community members who could most effectively utilize the equipment.

The solar ratings may additionally or alternatively be used to create tradeable securities, tax equity, or tranche funds. Tranche funds may spur investment by increasing predictability of revenue deriving from generating solar energy. Increased investment may ultimately increase the benefits available to be directed to the community interest and raise capital to support the various entities of the community power program.

Tranche funds may be structured to allow investors to invest in the community power program at various levels of risk, often defined by the aforementioned solar rating. The return on investment of a tranche fund may additionally or alternatively include depreciation as a key component. Depreciation may represent up to 85% of the value of equipment sold under manufacturers' current accelerated cost recovery schedules and allowances.

In some examples, the special purpose entity may perform the primary management duties of the community power program. The management duties may pertain to operating and installing energy generating equipment and to accounting for accrued benefits until they are directed to a community interest.

In some examples, special purpose entities may direct benefits to a separate receiver entity, which may then distribute the benefits to a community interest. Special purpose entities may be tasked with administering SPPAs or other agreements. In some examples, special purpose entities may be wholly or partially owned, managed, or operated by other parties of a community power program, such as solar service providers, separate receiver entities, or utilities.

In some examples, special purpose entities may perform marketing duties on behalf of associated community power programs, thereby allowing potential customers to identify a distinct brand associated with the program.

Special purpose entities may contract to receive benefits, such as renewable energy credits or saleable renewable energy credits, deriving from host community members using energy generating equipment. The special purpose entity distributes these benefits, including to community interests, such as separate receiver entities, green energy trusts, or community energy exchange programs, each of which are organized to direct funds to community interests.

Energy credits, in particular, may serve as vehicles through which grid energy may be transferred among parties. As a result, transferring these benefits allows host community members to provide energy to community interests (to the extent possible on the grid system). In some examples, special purpose entities may be funded by a portion of these same benefits.

In other examples, the special purpose entities may act as the primary interface between host community members and utilities. As previously mentioned, credits, beneficial tax treatment, and other subsidies and economic benefits, may be internalized as a discount of the prices host community members pay for their energy. In some examples, all or a portion of these discounts may be directed to a host community member. Additionally or alternatively, host community members may give up an individual financial reward in the form of discounted energy prices and instead pass along corresponding benefits to a community interest. Sharing benefits with the community encourages community-wide development of energy generating programs.

In some examples, independent investors may provide tranche funds, tax equity funds, or purchase solar securities structured to develop the community power program or produce benefits that may be contributed to the community interest. In other examples, investors, such as investors 160, may benefit the community power program by providing capital through investing in special purpose entity 158 or associated funds or other investment vehicles.

As FIG. 3 shows, host community member 152 defines a member of a community that has installed energy generating equipment 177 defining solar panels on his property. In some examples, host community members may define individuals, residences, businesses, or other owners of property that are members of an associated community.

In some examples, host community members may use a portion of the energy generated by energy generating equipment hosted on their property to satiate their own electrical consumption, but this is not required. For example, some host community members may define an energy generating facility that lacks significant structure beyond its energy generating equipment. Such examples may direct a portion of energy generated with the energy generating equipment to other community members or to community interest organizations. In some cases, host community members may define generation facilities, such as solar farms, power plants, or other facilities designed to generate electricity. In some such examples, host community members may be geographically distal one or more other community members, particularly in communities not strictly defined by geography.

As FIG. 2 shows, energy generating equipment is deployed on the host community member's property at step 106. Deploying the energy generating equipment on the host community member's property includes purchasing energy generating equipment and installing it on a host's property. In some examples, the host community member may purchase and install equipment on his own or according to agreements with other parties, such as an SPPA. In some cases, separate receiver entities may enter into an SPPA on behalf of hosts, to harness, for the community's benefit, benefits received (along with the per-unit of energy price paid for the power by the host community member) that exceed the cost of the equipment. In some examples, the energy generating equipment may define government-subsidized energy generating equipment. Government-subsidized energy generating equipment defines any energy generating equipment eligible for government-issued benefits, such as solar powered energy generating equipment, wind turbines, or other renewable energy generating equipment.

As FIG. 2 shows, a delivered portion of the energy generated by the energy generating equipment is delivered to the host community member, a receiving community member, or a utility at step 109. FIG. 3 illustrates an example, wherein host community member 152 is able to transmit, through power grid 178, energy to utility 162, a receiving community member 182, and a community interest organization 184 defining a school. In some examples, the host community member may deliver all generated energy to his own property to serve its energy demand. Some energy, however, such as surpluses, may be transmitted to other parties. As FIG. 3 illustrates, host community member 152 may direct, as a benefit, energy delivered to the community interest, either as electricity delivered to a community interest organization via a power grid or as energy credits that may be applied to a community interest's energy bill. For example, host community member 152 may donate a community portion of the energy generated by the energy generating equipment to a community organization, such as community interest organization 184. In some examples, associated community power programs may further direct to community interests a benefit received in response to delivering the community portion. The amount of this benefit may be determined, for example, by measuring the community portion of the energy delivered to the receiving community member from the energy generating equipment. The community portion of the energy may be measured by known metering or net metering methods. In some examples, the community power program may include energy storage equipment, such as batteries, fuel cells, or grid energy storage, to store energy until it is ready to be used by the host community member or other members of the community.

As FIG. 2 shows, the delivered portion of the energy is measured at step 112. This often includes currently understood energy metering techniques. In some examples, a meter, such as one provided by a utility, produces a measurement that reflects the amount of energy was generated by the energy generating equipment and delivered to a destination. In some examples, the measurement may include a representation of energy delivered to the host community member; in other examples, the measurement may include a representation of energy sent through an energy grid to other sources. Some examples may use net metering or other metering techniques, as described above.

As FIG. 2 shows, the amount of benefit received by community power program and/or directed to community interests may be calculated based on the measurement received at step 112.

In some examples, this measurement may reflect the amount of energy generated with the energy generating equipment. In some such examples, the benefits accrued may define transferable credits that may be donated to community interests to, in effect, provide community interests with a portion of the energy by the host community member. This may be useful to track the amount of energy hosts produce from renewable sources, such as solar panels or wind turbines. In some cases, the hosts or owners of renewable energy generating equipment are entitled to renewable energy credits, or other forms of compensation, based on the measured amount of renewable energy they generate.

Benefits may be initially directed to various parties, based on the terms of a particular community power/revenue program. In some examples, the benefits may first be received by the host before being received; in such examples, the host may then direct the benefit to the community interest in compliance with a community power program. In other examples, the benefit may be initially directed to another party to the SPPA, such as a utility, special purpose entity, or solar services provider. In such cases, they may direct the benefit to a community interest, either directly or through a separate receiver entity. In some examples, the benefits may additionally or alternatively be directed to other programs set up to benefit community interests, such as green energy trusts or community energy exchange programs.

In some examples, benefits may define credits or subsidies received from governments or private entities in exchange for producing renewable energy. These credits or subsidies are often transferable, where the receiving party may be able to use them to offset or reduce the cost of their energy generation or “costs” of operation as well as “fees” for after school program participation. These credits and subsidies may also be transferred for cash or other consideration, which may equally serve as a benefit. Examples of credits may include Revenue Credits, Energy Credits, Energy Share Credits, Renewable Energy Credits, and Net Metering Credits. In some cases, benefits may define government subsidies earned for generating energy with government-subsidized energy generating equipment, such as solar panels or wind turbines.

Indeed, there exist a great variety of benefits that may be directed to a community interest through a community power program. A non-exclusive list of such benefits that may be applicable to various examples is provided below:
Corporate Deductions;
Energy-Efficient Commercial Buildings Tax Deductions;
Corporate Depreciation;
Modified Accelerated Cost-Recovery System and Bonus Depreciation;
Corporate Exemptions;
Residential Energy Conservation Subsidy Exclusions;
Corporate Energy Conservation Subsidy Exclusions;
Business Energy Investment Tax Credits;
Renewable Electricity Production Tax Credit;
Grants supported by Federal Grant Programs;
Tribal Energy Program Grants;
U.S. Department of Treasury Renewable Energy Grants;
USDA supported High Energy Cost Grant Program grants;
USDA supported Rural Energy for America Program grants;
Loans administered by the Federal Loan Program;
Clean Renewable Energy Bonds;
Energy-Efficient Mortgages;
Qualified Energy Conservation Bonds;
Loans administered by U.S. Department of Energy's loan guarantee program;
Performance-based incentives;
Renewable Energy Production Incentives;
Personal Exemptions;
Residential Energy Conservation Subsidy Exclusions;
Personal Tax Credits;
Residential Energy Efficiency Tax Credits; and
Residential Renewable Energy Tax Credits.

In some examples, benefits may include referral fees, such as those earned by hosts, solar services providers, or marketing operations for recruiting new members to participate in the program. In some cases, solar service providers may pay these referral fees, wherein they may be transferred to a community interest, such as through a green energy trust fund.

In some examples, the benefit may not be strictly tied to the amount of energy generated. For example, hosts may often receive benefits, such as favorable tax treatment, energy credits, rebates, remuneration, or other financial incentives, in exchange for installing renewable energy generating equipment. In many cases, these may be earned upon purchasing or installing renewable energy generating equipment. These benefits, like those discussed previously, may be directed to the community interest.

The separate receiver entity is organized to direct benefit to one or more community interests. In many cases, the separate receiver entity is a school, school district, community interest organization, non-profit organization, foundation, charity, or other organization that is well-positioned to direct received benefits to community interests. In many cases, the separate receiver entity may be a non-profit entity. Often, the separate receiver entity defines a business entity, committee, or other organization created solely for an associated community power program formed to manage community members' accrued benefits and ultimately transacts them to community interests. In some examples, this may define a business entity that is organized to accumulate benefits and distribute them to community interests. In some examples, the separate receiver entity may direct funds from the special purpose entity to a green energy trust, general trust, or other organization that is arranged to hold or distribute assets on behalf of the community power program.

In some cases, separate receiver entities manage associated community power programs, and community members participate in community power programs by entering agreements with the separate receiver entities.

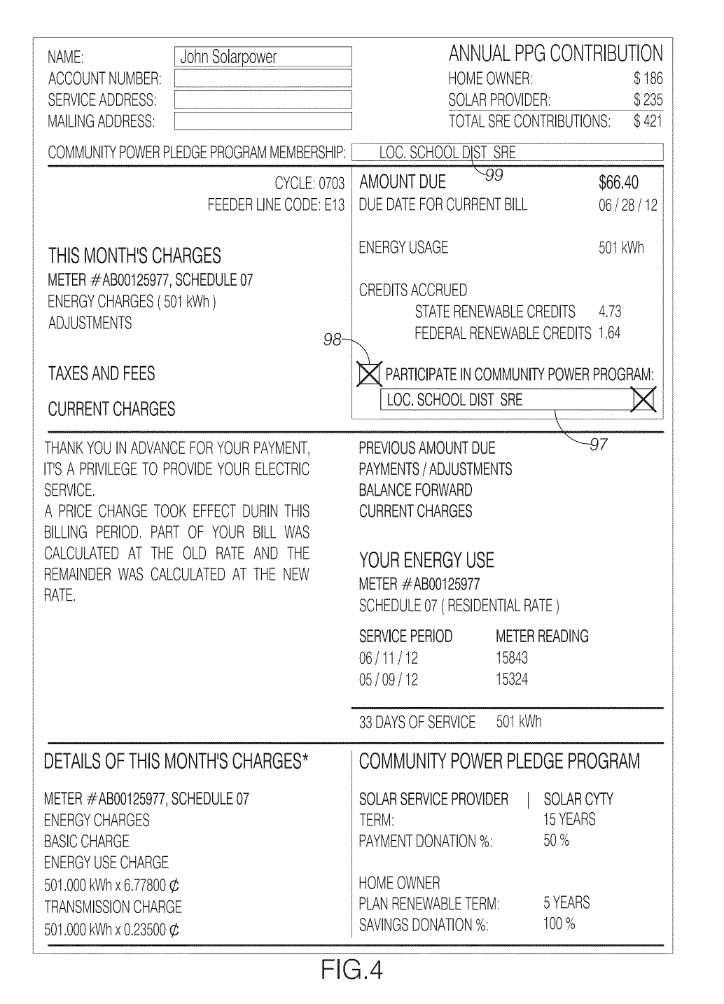

FIG. 4 illustrates one example of a means by which community members may participate in a community power program associated with that community. FIG. 4 illustrates an example form 95 defining a power bill of a member of a community with an established community power program 99, “LOC. SCHOOL DISTRICT SRE,” associated with the community member's school district. As FIG. 4 illustrates, the community member may choose to participate in a community power program from selecting a community power program participation entry 98 and selecting the desired community power program from a community power program list 97. Although list 97 includes only one entry, it may include more if the party receiving the bill is eligible to participate in multiple community power programs. As FIG. 4 illustrates, the community member may be told the amount of renewable energy credits or revenue generated over a billing period according to his current energy generation profile.

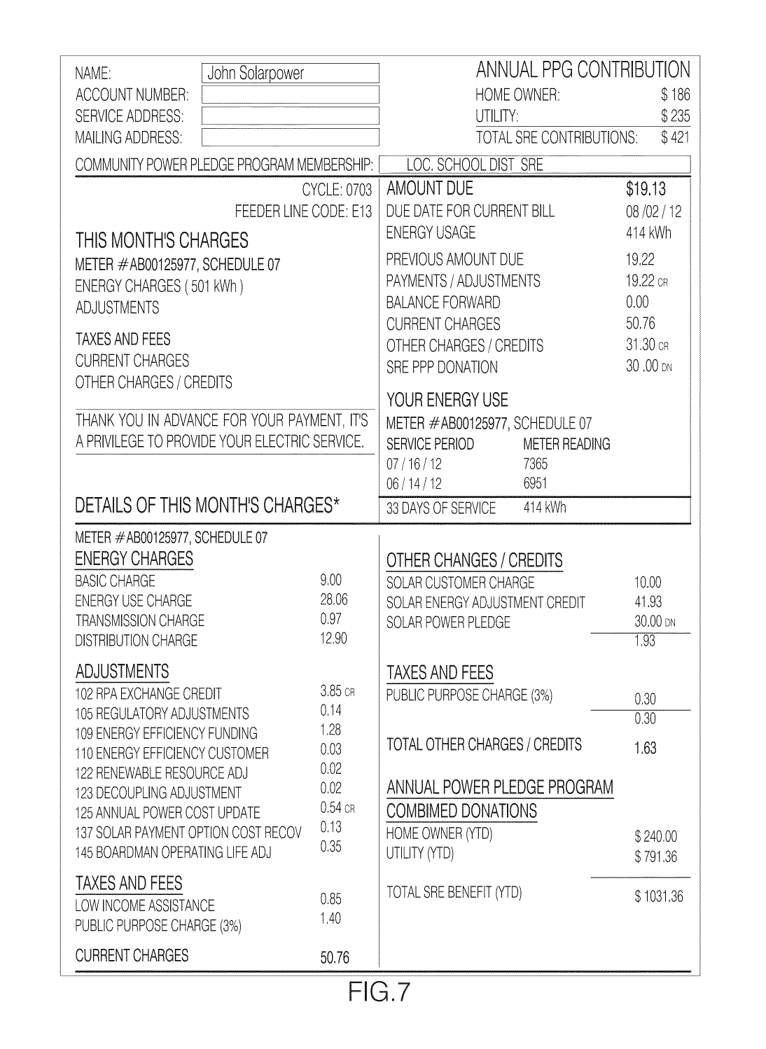

FIG. 7 illustrates another example of a power bill that illustrates how some of the benefits may accrue according to a particular community power program. For example, FIG. 7 includes a section illustrating “ANNUAL POWER PLEDGE PRO(RAM (SPP) COMBINED DONATIONS” that shows the amount donated to the community power program in the given year. Further, FIG. 7 illustrates the amount of benefits directed to a special purpose entity as a result of the participant's participation in the community power program in the “SRE SPP DONATION.” As FIG. 7 illustrates, this represents a portion of the accrued for the use of solar energy on the participant's property; the other benefits may be directed to other entities, such as the special purpose entity, utility, or other interested party, to partially subsidize the community power program.

In some examples, separate receiver entities may define or be integrated with already-established community interest organizations. For example, separate receiver entities may be a school district, individual school, other governmental entity, or other community interest organizations. In some examples, community members may define a collection of residences within a school district. In such examples, school districts may determine how to apply benefits received through community power programs to one or more receiver schools, which may be members of the school district.

In various examples, green energy trusts may be created and managed by special purpose entities or separate receiver entities. Such green energy trusts may be able to receive and hold benefits until separate receiver entities acquire them through a selection or application processes. Green energy trusts may allow benefits to be stored until community interest organizations or separate receiver entities comply with requirements directed by the trust. In some examples (particularly ones wherein community power programs may direct benefits to one or more community interest organizations), green energy trusts or SPE Foundation may include procedures that govern how money should be directed among different community interest organizations or separate receiver entities. In some examples, green energy trusts or foundations may have rules that direct that their funds must be directed to a community interest (or, in some cases, a particular separate receiver entity). In some cases, green energy trusts may define organizations organized to receive tax deductible donations.

In some examples, the separate receiver entity may direct benefits to a community energy exchange program, which operates to direct benefits received by hosts (or their agents) in exchange for a portion of the power generated with the energy generating equipment. In some examples, the separate receiver entity may operate the community energy exchange program. In some examples, community energy exchange programs may use energy share credits to reduce school districts' electric bills by donating a portion of the benefits accrued by community power program participants' use of renewable energy generating equipment. In some cases, this may result in a $500,000 (or even greater) discount. In some examples, community energy exchange programs may donate a fixed portion of a revenue benefit over the life of the solar system (typically 20 years) received in response to deploying or purchasing renewable energy generating equipment. In some typical cases, $1000 has been seen to be an appropriate value per sale to donate, providing the community interest with a meaningful amount while retaining enough to pay for the equipment and fund administrative costs of community power program parties. In some examples, community energy exchange programs may deploy renewable energy generating equipment at a community interest organization. The community energy exchange program may do this by using some or all of the benefits accrued by host community members. This disclosure contemplates that separate receiver entities, or any other entity performing the duties of a separate receiver entity, may additionally or alternatively perform all of the tasks discussed in association with the community energy exchange corporation. Further, community power programs may, in some examples, operate community energy exchange programs independent of a separate receiver entity.

In some examples, the separate receiver entity may be involved in marketing the community power program through a joint marketing effort with other parties in community power programs. In some examples, schools' booster clubs or parent-teacher organizations may join with special purpose entities, energy providers, or utilities in marketing the community benefits that may be achieved through community members' involvement in community power programs.

Further, separate receiver entities, special purpose entities, or solar services providers may, in some examples, be organized as a non-profit entity. This may allow certain organizations, including government entities, such as schools, to market for clean energy in a way that the schools themselves would not be able to do on their own. By establishing a separate receiver entity, such examples may provide sufficient insulation between the marketing entity and the community interest to allow the community interest to market for the community power program. Certain community interests may, for example, be prohibited from directly marketing for-profit activities. Because the community power program generally, and the separate receiver entity specifically, operate for the community benefit (and may potentially be non-profit entities), non-profit community interests may be able to advertise them directly in a way that they were not previously able. When separate receiver entities, special purpose entities, or solar services providers are organized as non-profit entities, they may be allowed to produce marketing materials that reference the community power program and tout the benefits of community power programs in a way that would not be allowed if for-profit entities were involved. In some examples, this may play out as a cooperative commercial marketing program between schools and separate receiver entities, special purpose entities, or solar services providers. This may, for example, allow schools, school districts, or booster clubs associated with schools to market on behalf of disclosed community power programs and methods.

Marketing materials coming from these specific sources may drive home to consumers the import and community benefit of joining the community power program, thereby increasing participation. The community interests (and associated organizations) may additionally be able to provide direct marketing to members of their community. For example, a school booster organization may be able to market the community power program to the club's members or to members of the school or district they support. The community interests/organizations may, in some examples, accrue referral fees or revenues as a result of their marketing efforts, which may be applied to further support the community interest.

In some examples, non-profit entities may direct money to special purpose entities, who may be able to use the money to market the community power program's benefit to the community. This may assist in allowing non-profit entities market on their behalf in ways that they would not otherwise be able to do.

As FIG. 2 illustrates, a portion of the benefit is distributed to a community interest at step 118. In some examples, benefits accrued by the separate receiver entity are distributed to a community interest; in many cases, this is accomplished by distributing the benefit to one or more community interest organizations. An example of such a community interest is illustrated in FIG. 3 as community interest organization 184 defining a school. In some examples, the benefit may define a fixed percentage of revenue based on measured energy converted to revenue and a representative portion of the monthly solar payment may be distributed to community interest, substantially similar to other benefits. By directing these benefits to a community interest or entity organized for the community's benefit, the directed benefits are converted to an investment in the community with an ongoing rate of return.

While FIG. 3 illustrates community interest organization 184 as a school, the community interest, in some examples, may define school districts, public buildings, or other public programs or funds (such as those directed toward local parks). In some examples, community interests may define private charitable causes. In some examples, communities may agree upon to benefit a particular cause or interest that does not directly benefit the community. Such examples may direct funds to charities or other organizations selected by the communities.

In some examples, community energy/revenue programs directing benefits to community interests may receive compensation, such as tax deductions or credits, in exchange for their charitable contribution of power. Some community energy/revenue programs may include methods for automatically directing the benefit of this compensation to the community interest.

In some examples, the benefit is contributed to the community interest by a separate receiver entity. In some cases, the separate receiver entity may acquire the benefit and contribute it directly to the community interest. This could occur, for example, when the separate receiver entity receives a credit received in response to operating the energy generating equipment.

In other cases, the separate receiver entity may sell the benefit to a third party (or one of the other participants in the community power program, such as the utility) and direct the proceeds to the community interest.

In some cases, the benefit may be contributed to the community interest by way of one of the other participants of the community power program. For example, the host community member may receive credits for deploying or operating energy generating equipment. The host community member may direct received credits to a special purpose entity, a utility, investors, a solar services provider, or other parties, prior to them ever reaching the separate receiver entity. These other members may sell credits and distribute proceeds as well, as described above. This may be useful, for example, if other participants in community power programs designed to distribute a selected percentage of accrued benefit to the community interest, while using some of the residual benefit to financially assist the program.

In some examples, photovoltaic-based energy generating equipment may be sold and installed on the property of a community member. In some such examples, rather than paying the solar energy payment that normally would go to a solar provider or a financier from the Utility, who measures the generated energy, a portion of the solar payment, the portion predetermined by the community energy/revenue program, and a portion of savings that result from using solar energy may be distributed to special purposes entities as digitally or monetized credits. These special purpose entities may be organized primarily for the public benefit, in some examples. The special purpose entities may, in return, distribute the funds to separate receiver entities or community interest organizations, such as school endowments. In some cases, these benefits directed by the special purpose entity may be directed in return for cooperative marketing efforts performed by separate receiver entities or community interest organizations.

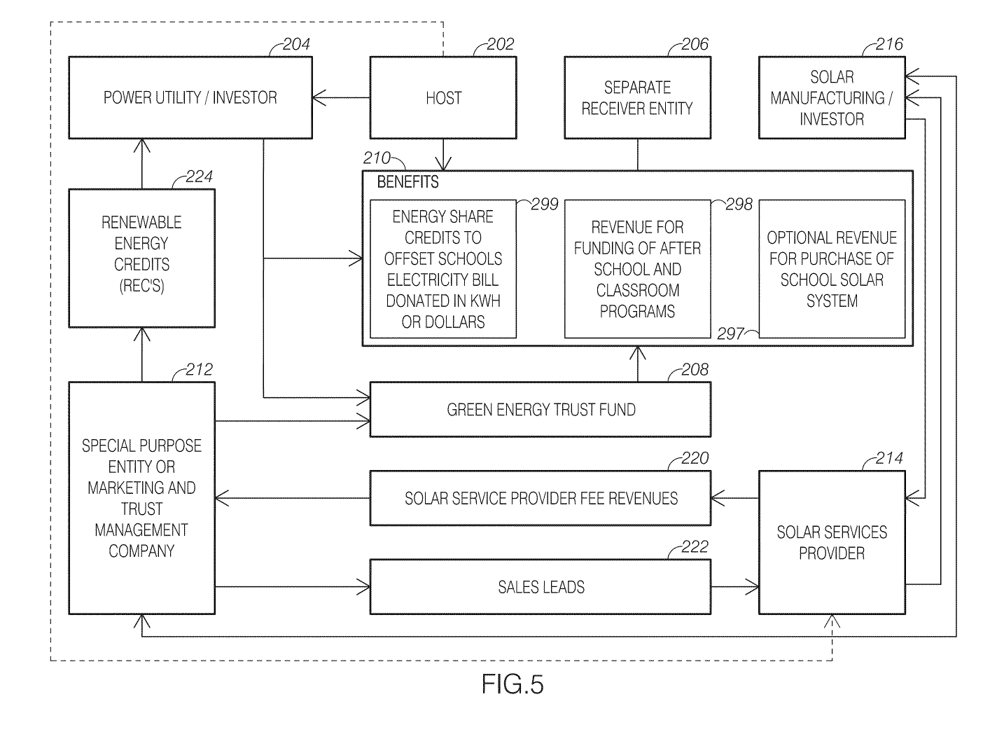

With reference to FIG. 5, a second example of community power program for allocating benefits received in response to generating energy within a community to a community interest, program 200, will now be described. As FIG. 5 illustrates, program 200 includes many features similar or identical to method 100. For the sake of brevity and clarity, some of these common features may not be described in detail. Rather, the discussion of program 200 may focus on additional or alternative features of the method shown in FIG. 5.

As FIG. 5 illustrates, program 200 includes a host 202, a utility 204, a separate receiver entity 206, a green energy trust fund 208, a special purpose entity 212, a solar services provider 214, and solar manufacturers and investors 216, and a community interest organization 218.

Host 202 hosts renewable energy generating equipment on his property, which generate benefits that may ultimately be directed to community interest organization 218. In some examples, host 202's use of renewable energy generating equipment generates digitized or monetized “energy share credits” measured using standard net metering. In other examples, host 202 generates solar renewable energy credits. These credits may be used to re-distributed or aggregated energy in the form of “offsets” that may be applied to reduce a party's energy cost.

Utility 204 may, in some examples, provide grid power to host 202 to supplement the host or home owners' own photovoltaic solar production. Utility 204 may also, in some examples, perform the net metering and redistribution of credits, often to separate receiver entities. Some utilities may purchase additional or alternative credits from solar services providers or special purpose entities. In some examples, utilities may provide funding as an investor. In various examples, utilities may participate in revenue sharing with one or more other parties, which may allow the parties to more efficiently cooperate in coordinating associated community power programs.

Solar manufacturers and investors 216 provide funding and renewable energy generating equipment to program 200. Investors and manufacturers to achieve more mobile and flexible profit margins through efficiencies and economies of scale, tax deductible power donations, more effective use of accelerated depreciation, and power utility subsidies. These parties may, in some examples, achieve a higher per unit sale price through a unique value proposition of a low to no cost solar system to host 202 and the energy it provides to host 202 and separate receiver entity 206. As an example, solar panel producers may supply a tranche tax equity fund to provide funding to solar providers. This would allow the return on investment to be leveraged primarily by depreciation and the revenues received from the power generation. Additionally or alternatively, tax deductible energy share credit or converted revenue payment donations and government or utility subsidies may augment the return on investment. In some examples, solar manufacturers and investors 216 and utility 204 may participate in revenue sharing with special purpose entity 212. This may include profit margin balancing to correct inequities between manufacturing partners or tranche funds and special purpose entities. Such revenue sharing may additionally or alternatively include solar service providers as a participant.

In some examples, the adjusting of the value proposition may result in increasing the marginal value of installing renewable energy generating equipment, thereby making the prospect of installing renewable energy generating equipment more attractive to members of the community. As a corollary, of course, the de facto cost of installing renewable energy generating equipment may go down, and members of the community, including residence owners and businesses, may install energy generating equipment on their property at a cost that reflects the adjusted value proposition. In some cases, adjusting this value proposition may create a platform for smart grid investment at a local level. This may result, in part, due to the likelihood of increasing the density of installations that will ultimately result from the adjusted value proposition.

Solar services provider 214 acts as a provider of photovoltaic systems for residential properties. Solar services provider 214 receives funds from solar manufacturers and investors 216, such as from a tranche tax equity fund. As FIG. 5 illustrates, solar services provider 214 directs solar service fee revenues 220 to special purpose entity 212. In some examples, solar service fee revenues 220 may include referral fee revenues acquired from unit sales of residential solar systems. In some examples, solar service fee revenues 220 may include lead generation revenue or “order processing” fee revenues. In some examples, solar service fee revenues 220 may include program service area participation fee revenues.

Special purpose entity 212 performs many of the administrative tasks associated with program 200. This may include managing operational, marketing, and distribution revenues. These revenues may be generated in two phases. A first phase may include lead generation, solar system sales, referral fee processing, school sports wear sponsoring, and governmental/utility grants. A second phase may include revenues from solar system energy, solar service providers, receipt of renewable energy credits accrued from generating energy, a tax equity tranche fund (such as those previously mentioned), solar panel manufacturing, and government sponsorship.

As FIG. 5 illustrates, separate receiver entity 206 may generate sales leads 222 and direct them to solar services provider 214. These sales leads may include information about potential customers or orders to “process” one or more approved solar providers in a targeted service area, such as a school district.

Green energy trust fund 208 provides tax deductible revenue distributions. These funds may be applied for by schools in need of budget assistance in the form of electrical energy through an “energy share credit” program or other similar program. These funds may also include actual funds realized through the sale of solar systems in a targeted service area.

As FIG. 5 shows, special purpose entity 212 may also provide a home owner rebate 224 that benefits one or more hosts. In some examples, this may amount as much as 20% of hosts' energy bill. This may amount as much as $10,040 over the life span of an example system installed by an example host.

One or more parties may direct benefits, such as those included in benefits 210 to separate receiver entity 206. These benefits may include energy share credits 299, used to offset schools' electricity bill and donated in kWh or Dollars, program revenue 298, for funding of after-school, classroom, or other school sponsored programs, and/or purchasing revenue 297, for purchasing of renewable energy generating equipment to be installed at schools.

Separate receiver entity 206 is organized to direct benefits, such as benefits 210, to community interests and community interest organizations. For example, separate receiver entity 206 may direct benefits to schools or school districts to benefit the communities in which they are a part. Separate receiver entity 206 may, in other examples, direct benefits to governmental entities, such as governments, commissions, or funds that support community projects. Separate receiver entity 206 may also, in some examples, private entities that support development in the community, such as charitable organizations. These benefits may be used by community interest organizations, for example, to offset a portion of their energy bills, support that organization's programs (such as after-school or classroom programs, in the case of schools), or develop renewable energy projects on their property.

Separate receiver entity 206 may additionally administer a community energy exchange program to distribute benefits to community interests and/or community interest organizations. This community energy exchange program may, for example, include an energy share credit program that offsets electric bills of community interest organizations with credits donated by hosts (or other parties of program 200). These credits may, in some examples, correspond to a portion of the energy generated by hosts and donated to separate receiver entity 206 for the community benefit. The community energy exchange program may additionally or alternatively include benefits received in connection with the sale of energy generating equipment to hosts. This may include benefits received in connection with the sale or a donation made at the time of sale, either by host or by another party on behalf of host. In other examples, community energy/revenue programs may direct benefits that may be used by community interest organizations to develop renewable energy generation projects, such as installing photovoltaic panels, on community interest organizations' property.

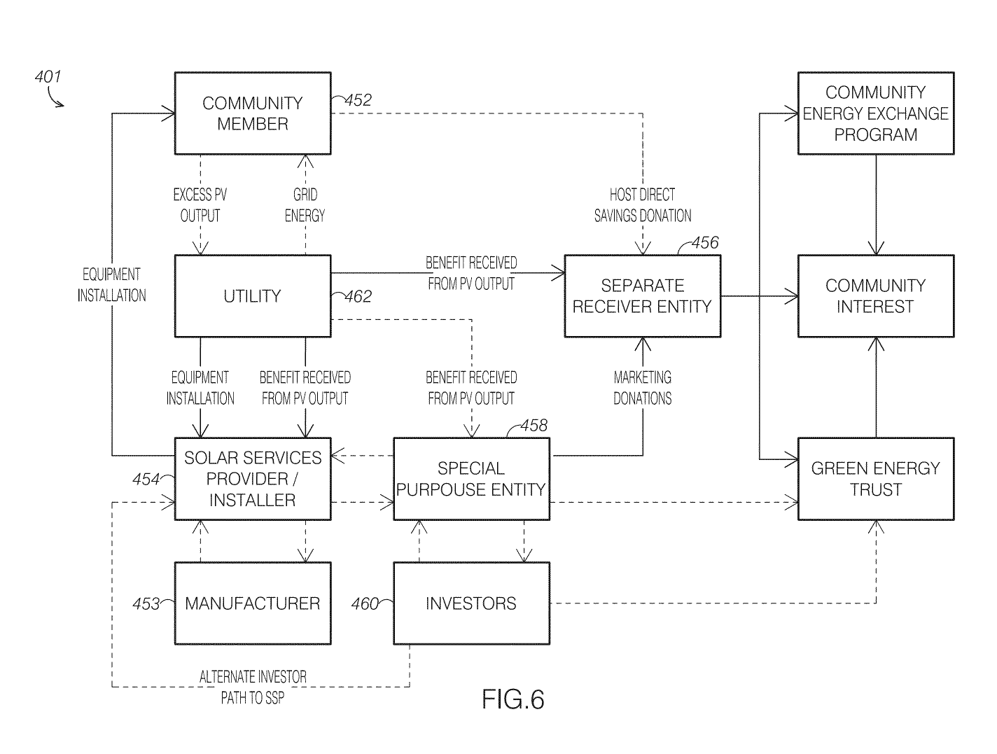

FIG. 6 illustrates an additional or alternative example of an organizational scheme for a community power program. The example illustrated in FIG. 6 includes many features that are substantially similar to many features in the examples shown in FIGS. 1 and 5. As a result, each and every feature of FIG. 6 will not be described. Rather, differences between FIG. 6 and previous examples will be discussed.

As FIG. 6 illustrates, the roles of utility 462 and community member 452 have been adjusted slightly. In the example shown in FIG. 6, utility 462 receives grid energy, which may include photovoltaic output that exceeds the host community member's energy consumption, until directing them to a separate receiver entity. Further, utility 462 may direct grid energy to community member 452 that helps satiate the community member's energy consumption.

Utility 462 may additionally or alternatively direct benefits to a solar services provider 454 and/or a special purpose entity 458. These two parties may use these funds to administer the community power program. Associated expense may include, for example, marketing the program, running the services necessary to track the amount of benefits accrued, distributing funds to investors, etc. Solar services provider 454 will often install the equipment on community member 452's property; in many cases, this will be either funded or subsidized by benefits accrued from the community power program.

FIG. 6 illustrates marketing donations being directed to separate receiver entity 456. As discussed above, separate receiver entities are often non-profit organizations. As a result, it may not be possible for separate receiver entities to market on behalf of each and every member community power programs. Separate receiver entity 456, however, receives, as a part of the benefits received in the community power program, a donation that may be applied for marketing purposes. Using this marketing donation, separate receiver entity 456 may be able to market the community power program without improperly marketing on behalf of other interested entities. As a result, separate receiver entities may apply a portion of benefits accrued as a result of community member 452's participation in the community power program to the development of marketing materials that can be distributed to additional or alternative community members.

Like in past examples, certain parties in the example shown in FIG. 6 may vertically integrate to make community power programs more economically efficient. In some examples, solar services providers, installers, special purpose entities, and utilities may be vertically integrated; indeed, this is how many community power programs will operate. In such examples, the single vertically integrated entity may administrate one or more community power programs, provide the community member with energy generating equipment, and direct benefits to a separate receiver entity. This separate receiver entity may then use the funds for its own purposes or further distribute it to additional or alternative interests that benefit the community as a whole.

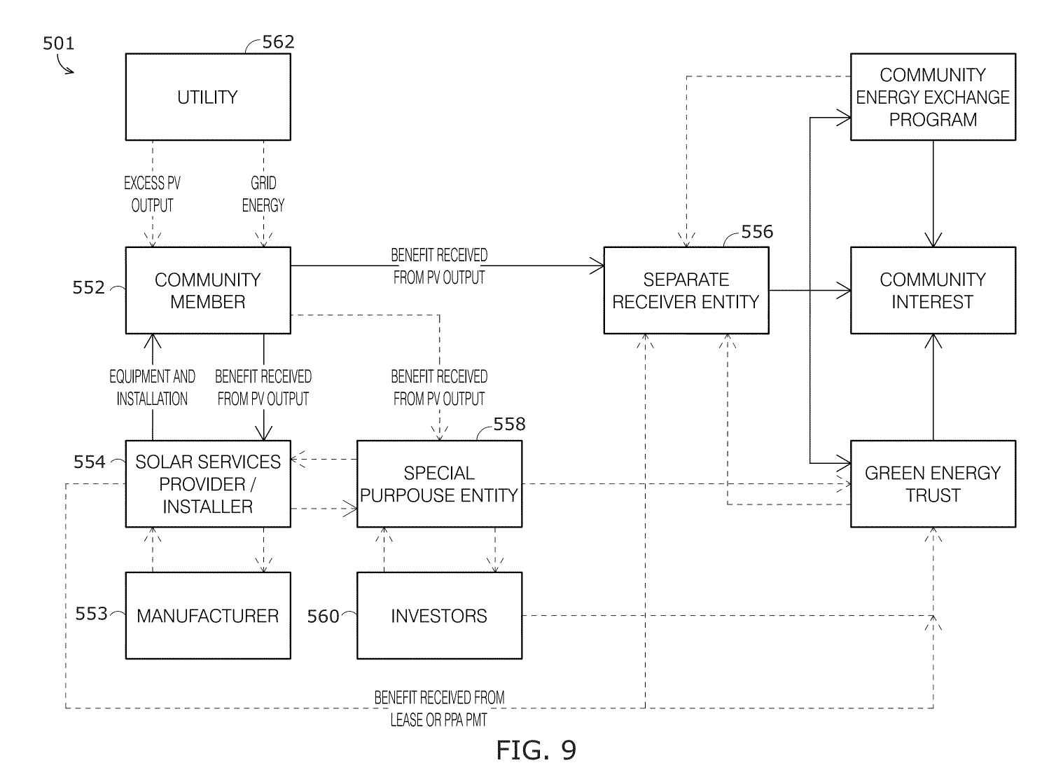

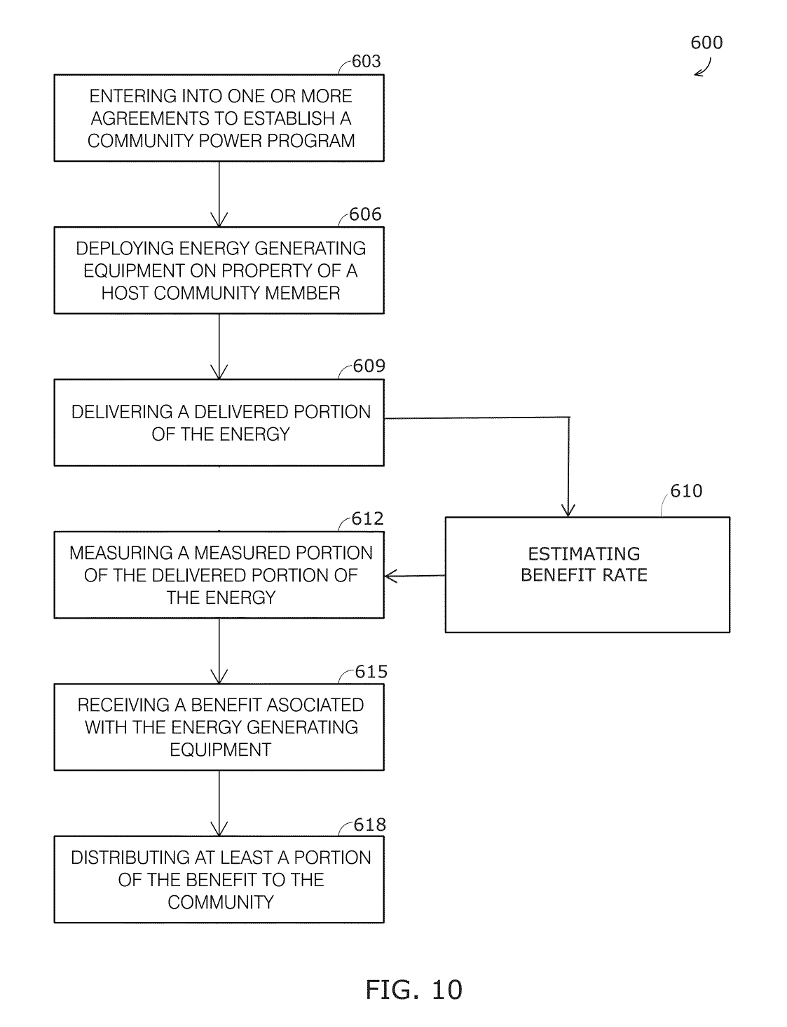

Turning attention to FIGS. 9 and 10, another example of a method for allocating benefits derived from generating energy from renewable power sources within communities, method 600, will now be described. As FIGS. 9 and 10 show, method 600 shares many similar or identical features with the methods described above combined in unique and distinct ways. For the sake of brevity, each feature of method 600 will not be redundantly explained. Rather, key distinctions between method 600 and the methods discussed above will be described in detail and the reader should reference the discussion above for features substantially similar between the different methods.

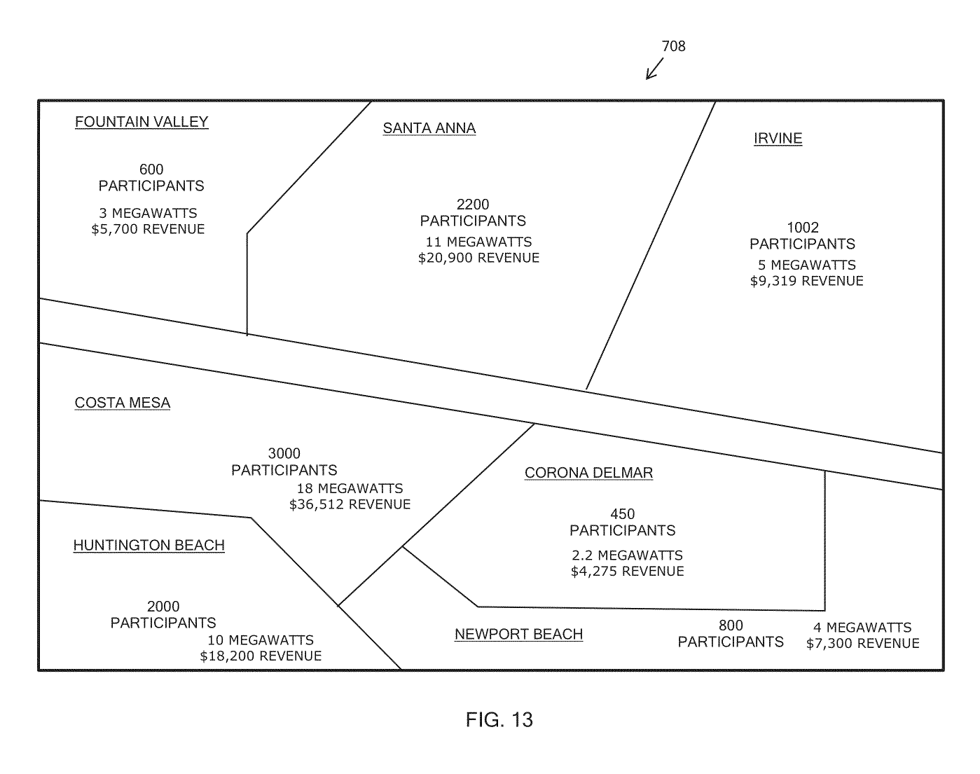

FIG. 9 illustrates an organizational scheme for a third example of a community energy/revenue program, similar in many ways to the community power programs shown in FIGS. 1 and 6. As FIG. 10 illustrates, method 600 includes entering into one or more agreements to establish a community power program at step 603, deploying energy generating equipment on property of a host community member at step 606, delivering energy at step 609, estimating a benefit rate according to an expected generated energy value at step 610, measuring a measured portion of the energy delivered at step 612, receiving a benefit associated with the energy generating equipment at step 615, and distributing at least a portion of the benefit to the community at step 618. FIG. 13 provides depicts a schematic sky view of a community 708 employing a community energy/revenue program with various participation levels by community members in different regions of the community.

The community energy/revenue program established at step 603 may be organized similar to community power program 501 illustrated in FIG. 9. As FIG. 9 shows, community power program 501 includes a lease agreement between a host community member 552 and a solar services provider 554. The lease agreement provides that host community member 552 will pay a fixed payment per month to solar services provider 554 in exchange for host community member 552 possessing and using the energy generating equipment deployed on his property.

Similar to previous examples, host community member 552 delivers a portion of the energy generated with the energy generating equipment to a utility 562 in FIG. 9 at step 609 of the method shown in FIG. 10. The portion delivered to utility 562 at step 609 may be referred to as a delivered portion.

As FIG. 10 shows, a benefit rate is estimated at step 610 according to a prediction of the amount of energy that will be generated by host community member 552. The predicted amount of energy that host community member 552 will generate is referred to as an expected generation energy.

In some examples, the expected generation value is the amount of energy that generating equipment is expected to generate when deployed on the host community member's property. The expected generation value may be a prorated, periodic value associated with the amount of energy expected to be generated over the lifetime of the energy generating equipment. In some examples, the expected generation value may take into consideration the environment of the host community member's property, including the property's exposure to sunlight and/or wind, the climate of the host community member's property, and other factors that may impact the energy generating equipment's ability to generate energy.

The expected generated energy value may be estimated at the outset of a power purchase agreement or community power program and remain fixed over the life of the agreement. However, in some examples, the expected generated energy value may be adjusted at times to reflect changes that may impact the energy generating equipment's ability to generate energy.

The benefit rate determines the amount of benefits received for generating energy with the energy generating equipment in the future. For example, the benefit rate may be proportional to the expected generated energy value. The benefit rate may, for example, define a fixed payment that is directed to the host community member (or other interested party) in a periodic manner. In some examples, the benefit rate remains fixed over the life of a community power program and/or power purchase agreement.

The benefit rate may account for a discount on a lease payment owed by the host community member to a solar services provider (or other party that leased the energy generating equipment to the host community member). For example, the benefit may be a discounted lease payment. The discounted lease payment may be applied periodically based on a fixed benefit rate and/or expected generation value. In such examples, the benefit rate may account for the periodic discounts applied over the life of the community power program and/or power purchase agreement.

Similar to previously disclosed examples, the delivered portion of the energy may be measured at step 612. The delivered portion of the energy may be measured with any suitable metering equipment or methods, such as net metering equipment and methods.

A benefit associated with generating energy with the energy generating equipment is received at step 615. The benefit may be determined based on an expected generation value and/or a benefit rate determined therefrom. In some examples, the benefit is prorated over a number of periods and be proportional or otherwise calculated based on the expected generated energy value associated with that period. In some examples, the benefit includes one or more discounts applied to lease payments paid by the host community member in association with the energy generating equipment or other payments associated with a power purchase agreement or community power program. For example, a solar services provider may, rather than apply a discount, withhold at least a portion of the discount to later apply the withheld discount to a community interest.

In some examples, the discount represents avoiding a cost that would otherwise need to be paid to a utility. In such examples, the money saved by avoiding the cost may be directed to a solar services provider, other interested party, or directly to a community interest rather than providing a discount to the host community member.

During some periods, the host community member may generate more energy with the energy generating equipment than expected. In such examples, the host community member may receive, from a utility or other interested party, a reconciliation payment at the end of a period (e.g. monthly or annually) that accounts for the excess generated energy. The benefit may include all or a portion of the reconciliation payment. For example, a solar services provider may retain a portion of reconciliation payment to direct it to a community interest instead of returning it to the host community member.

During some periods, the host community member may generate less energy with the energy generating equipment than expected. In such examples, the host community member may pay a surcharge on the associated periodic payment to reflect the difference between the amount of energy expected to be generated by the energy generating equipment during the corresponding period and the measured amount of energy actually generated.

Similar to other examples, host community member 552 and/or other interested parties (such as utility 562, solar services provider 554, special purpose entity 558, manufacturer 553, or investors 560 depicted in FIG. 9) may receive a benefit for generating the energy at step 615 of FIG. 10. The benefit may include energy credits or other compensation for generating clean and/or renewable energy.

As FIG. 10 shows, at least a portion of the benefit is distributed to a community interest at step 618. The portion of the benefit may be directed to the community interest in any disclosed manner. As FIG. 9 shows, solar services provider 554 directs a portion of a lease payment (or a withheld discount thereof) to the community interest.

In some examples, the host community member may direct benefits to the community interest directly. For example, the host community member may have avoided costs by using the energy generating equipment, received energy credits for using the energy generating equipment, or received discounts to payments associated with a community energy/revenue program, such as discounts on lease payments owed to a solar services provider. The host community member may distribute these benefits directly to a community interest, rather than directing them to solar services provider 554, special purpose entity 558, separate receiver entity 556 or other entity that may be organized to manage the benefits accrued for generating energy with the energy generating equipment.

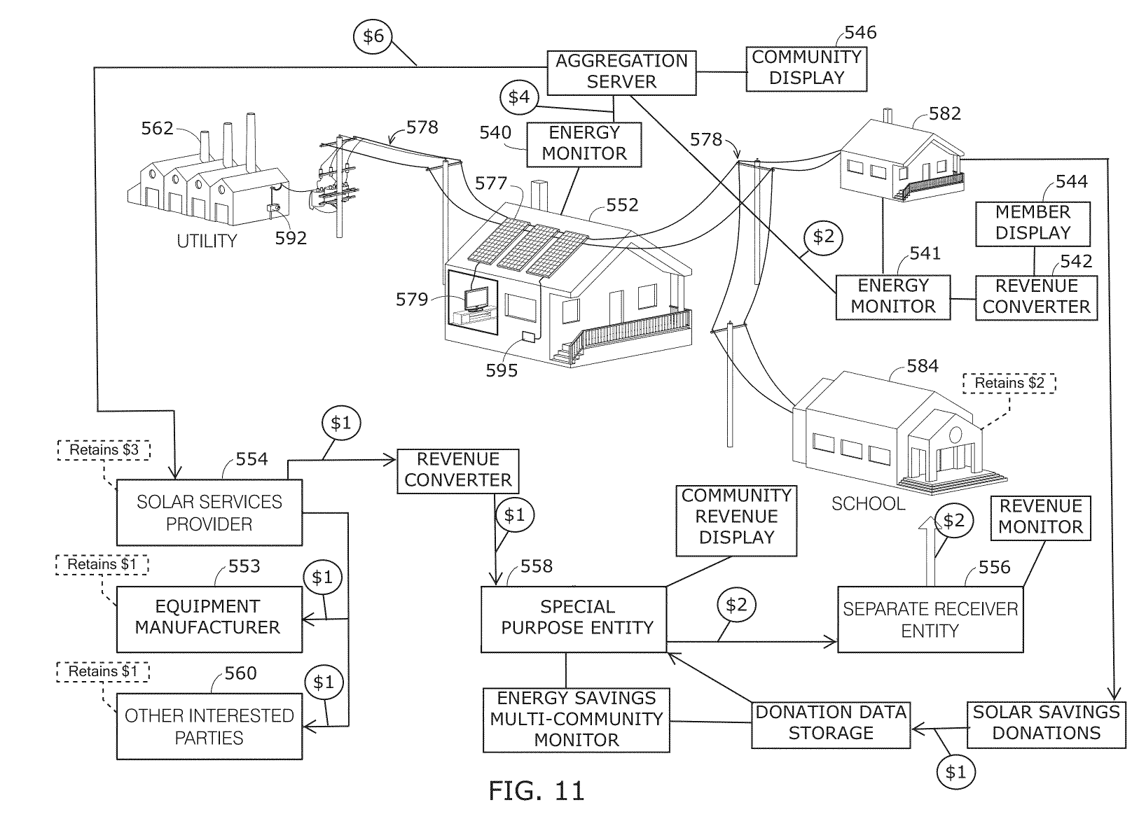

Turning attention to FIG. 11, a schematic view showing relationships among selected parties in the community power program will be briefly explained. The relationships shown in FIG. 11 are similar to the relationships shown in FIG. 3. Thus, only the key distinctions need be elaborated upon.

As can be seen in FIG. 11, energy monitors 540 and 541 are in data communication with properties owned by community member 552 and community member 582, respectively. In the present example, energy monitor 540 is in data communication with meter 595. Energy monitors 540 and 541 are configured to monitor how much energy is generated and consumed by devices connected to the monitors. The devices may be power generating devices like energy generating device 577 or power consuming devices like electrical device 579.

With particular reference to energy monitor 541, the reader can see that a revenue converter 542 is in data communication with energy monitor 541 and a member display 544 is in data communication with revenue converter 542. Energy monitor 540 may be in data communication with a revenue converter and a member display as well. Energy monitors 540 and 541 are in data communication with aggregation server 545.

Revenue converter 542 is configured to calculate monetary values associated with energy amounts monitored by energy monitor 541. Revenue converter 542 may comprise a computer with one or more components discussed in connection with FIG. 8.

The monetary values calculated by revenue converter 542 may include revenues, discounts, expenses, energy credits, or tax benefits. Cost parameter data may be stored into non-volatile memory accessible by or onboard revenue converter 542. The cost parameter data may be static or variable; that is, the cost parameter data may be relatively constant or dynamically changing, respectively.

Member display 544 may be any currently known or later developed computer display and is configured to display energy metrics obtained from energy monitor 541 and revenue converter 542. In some examples, the member display obtains data from either the revenue converter or the energy monitor, but not both.

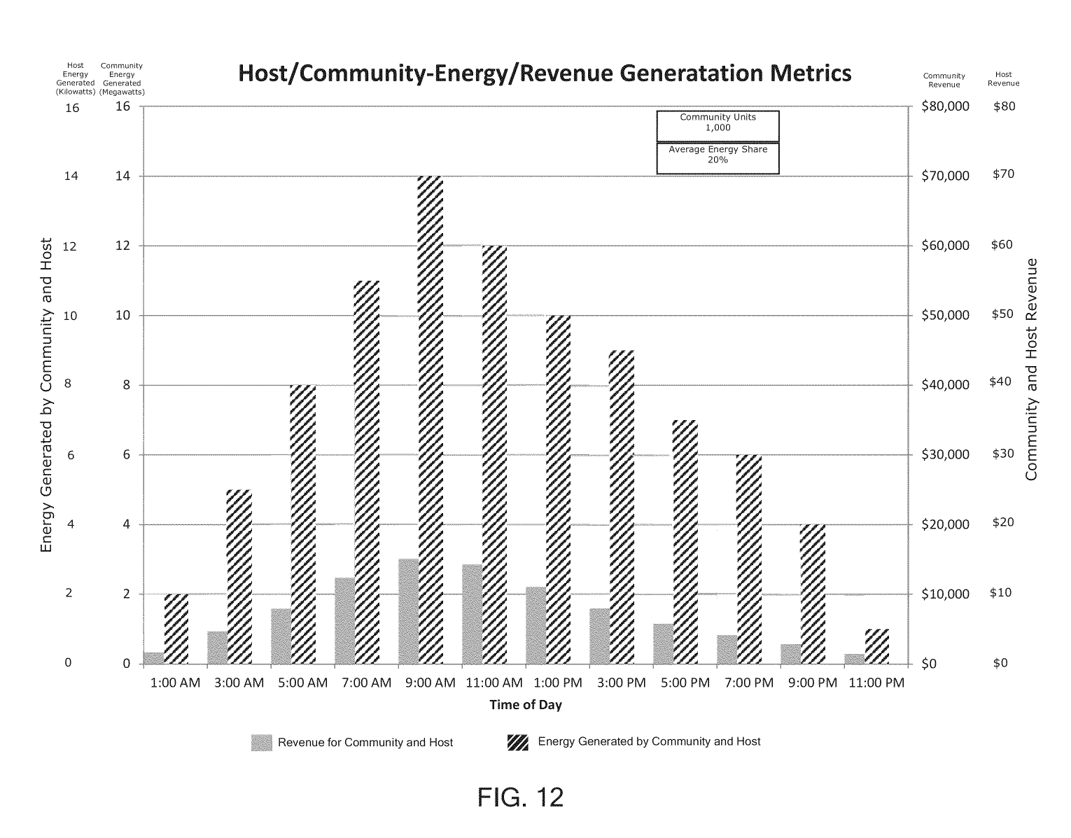

While FIG. 12 depicts a display of community wide energy metrics on community display 546, the FIG. 12 display proves a representative sample of energy metrics that may be displayed on member display 544. However, with member display 544, the energy metrics will typically be specific to energy metrics associated with the community member's property rather than for the community as a whole. It is important to recognize that the member display may be configured to display community-wide energy metrics as well or the metrics associated with a neighbor.

Aggregation server 545 is in data communication with energy monitor 540 and energy monitor 541 (as well with other energy monitors installed in the community but not pictured in FIG. 11). Additionally or alternatively, aggregation server may be in data communication with meter 592 measuring energy provided by utility 562. Aggregation server 545 is configured to collect energy metric data from energy monitors and to compile them for the community as a whole. The reader will understand that aggregation server 545 is a computing device and will utilize one or more of the computer components shown in FIG. 8.

Aggregation server 545 may is configured to calculate monetary values associated with energy amounts monitored by energy monitors in data communication with aggregation server 545. The monetary values calculated by aggregation server may be similar or identical to those calculated by revenue converter 542. Indeed, aggregation server may calculate monetary values associated with revenues, discounts, expenses, energy credits, or tax benefits relating to energy generation and energy consumption. To enable aggregation server 545 to calculate monetary values, aggregation server is configured to access cost parameter data. The cost parameter data may be stored into non-volatile memory onboard the aggregation server, stored in memory in a remote location and accessed by the aggregation server, or input into or sent to the aggregation server as needed. The cost parameter data may be static or variable; that is, the cost parameter data may be relatively constant or dynamically changing, respectively.

The aggregation server may be configured to receive data queries from a variety of users, such as community members interested in community energy metrics and/or cost parameters. To facilitate communicating community energy metric and monetary value data, aggregation server 545 is in data communication with community display 546 and is configured to send community display data to community display 546. A sample display suitable for displaying on community display 546 is provided in FIG. 12.

With reference to FIG. 12, the reader can see that community display 546 may display community energy generation metrics in a chart format, such as a bar chart, a line chart, a scatter plot, a pie chart, and the like. In the present example, community display 546 displays energy collectively generated by a community at different times of the day. Further, community display displays revenue associated with generating energy at different times of the day.

Of course, any suitable information may be displayed on the community display. For example, the community display may display breakdowns between how much of a benefit is retained by host members versus how is directed to a community interest. Additionally or alternatively, the display may display energy generation metrics and/or revenue metrics on a daily, weekly, monthly, or yearly basis. Average values for a given metric may be displayed as well as other statistical metrics, such as standard deviations, variations, and confidence values. In some examples, the community display displays aggregate values for the community as a whole and in other examples values for individual community members may be selectively and individually displayed.

With reference again to FIG. 11, the reader can see that aggregation server 545 is configured to transfer energy metrics and monetary value data to a party responsible for distributing benefits and fees, such as special purpose entity 558. In the FIG. 11 example, community member 552 generates benefits worth $4 for a particular time period and community member 582 generates benefits worth $2. Aggregation server 545 aggregates these benefits and passes on the $6 in total benefits to solar services provider 554 to distribute.

Solar services provider 554 then distributes the total benefits according to a distribution schedule, which may include static or variable distribution factors. In the present example, solar services provider 554 keeps $3 of the benefits and distributes $1 of the $6 in total benefits to special purpose entity 558. The reader will note that FIG. 11 schematically depicts the $1 in benefits from solar service provider 544 passing through a revenue converter before being passed on to special purpose entity 558. The revenue converter will account for benefits that are not immediately liquid or transferable, e.g., favorable tax treatment, and convert them to a monetary equivalent benefit that may be transferred, e.g., money.

The other $2 left for solar services provider 554 to distribute are distributed to equipment manufacturer 553 and other interested parties 560. In the present example, equipment manufacturer 553 receives $1 and other interested parties 560 receive $1. Of course, other arrangements for dividing benefits may be employed as appropriate for a given situation.

In some examples, a distribution factor may specify that community members receive ½ of the benefits they generate, community interests receive ¼ of the benefits, and the group of the solar services provider, the equipment manufacturer, and the other interested parties receives ¼ of the benefits. In other examples, other distribution schedules are employed, including schedules where no benefits are directed to one or more of the parties discussed above.

FIG. 11 shows that special purpose entity 558 aggregates benefits received from solar services provider 554 and from solar savings donations. In the FIG. 11 example, community member 582 donates $1 of his solar savings and thus special purpose entity 558 has a total of $2 to send to community interest 584 via separate receiver entity 556. Data specifying that community member 582 has donated $1 in solar savings is optionally stored in donation data storage.

As depicted in FIG. 11, a community revenue display may be in data communication with special purpose entity 558 for reporting how much revenue special purpose entity has received and/or passed on to community interest 584 via separate receiver entity 556. An optional energy savings monitor configured to monitor energy savings in multiple communities is in data communication with special purpose entity 558 and donation data storage. The reader can see in FIG. 11 that a revenue monitor may be in data communication with separate receiver entity 556 as well.

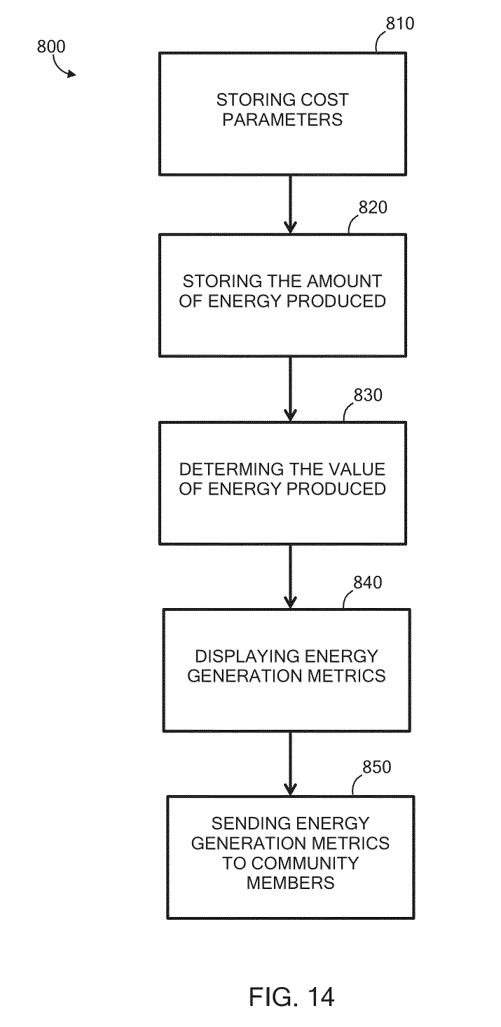

With reference to FIG. 14, a method 800 for displaying information related to energy generated by a community will be described. In particular, method 800 displays information related to energy generated by a community with energy generating equipment installed on property of members of the community. Method 800 includes storing cost parameters at step 810, storing the amount of energy produced at step 820, determining the value of energy produced at step 830, displaying energy generation metrics at step 840, and optionally sending energy generation metrics to community members at step 850.

Storing cost parameters at step 810 may include storing into non-volatile memory cost parameters that specify the value of energy produced by the energy generating equipment. The cost parameters may be static or may change dynamically. In examples where the cost parameters change dynamically, storing the cost parameters into non-volatile memory may include dynamically updating the cost parameters in the non-volatile memory.

Storing the amount of energy produced at step 820 may include storing into non-volatile memory a measured amount of energy produced by the energy generating equipment. Any standard measuring equipment, such as energy meters may be employed to measure the energy. Additionally or alternatively, storing the amount of energy produced at step 820 may include storing a plurality of measured amounts of energy produced by energy generating equipment installed on the property of a plurality of members of the community, respectively.

Determining the value of energy produced by the energy generating equipment at step 830 may include executing computer executable instructions to compare the cost parameters with the measured amount of energy generated. Executing the computer executable instructions may be accomplished with a microprocessor.

Displaying energy generation metrics at step 840 may include displaying one or more of the measured amount of energy produced and the value of the energy produced. Computer executable instructions may be employed in conjunction with a microprocessor to display the metrics.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method of allocating benefits received in response to generating energy within a community to a community interest, comprising:
deploying energy generating equipment on property of a host community member,
receiving a benefit associated with purchasing the energy generating equipment or generating energy with the energy generating equipment;
estimating a benefit rate according to an expected generation value, the expected generation value defining an amount of energy expected to be generated by the energy generating equipment at a later time;
distributing at least a portion of the benefit to the community interest, the portion of the benefit distributed to the community interest calculated based on the benefit rate.

2. The method of claim 1, further comprising:
delivering a portion of the energy generated by the energy generating equipment to the host community member, a receiving community member, or a power grid to define a delivered portion; and
measuring the delivered portion to define a measured amount of energy;
wherein the benefit rate is determined based on the difference between the measured amount of energy and the expected generation value.

3. The method of claim 2, wherein measuring the delivered portion of the energy to define a measured amount of energy includes:
deploying metering equipment on the property of the host community member; and
measuring the delivered portion of the energy with the metering equipment.

4. The method of claim 2, wherein the host community member satisfies at least a portion of its energy demand from energy supplied by a utility in exchange for a utility payment the host community member pays to the utility, and further comprising:
discounting the utility payment owed by the host community member by a discount amount corresponding to the difference between the measured amount of energy and the expected generation value or the difference between the measured amount of energy and the actual generation value; and
distributing at least a portion of the discount amount to the community interest in the form of revenue or in the form of energy credits having a monetary value equivalent to the revenue.

5. The method of claim 1, further comprising distributing a host portion of the benefit to the host community member.

6. The method of claim 5, further comprising:
delivering a portion of the energy generated by the energy generating equipment to the host community member, a receiving community member separate from the host community member, or a power grid to define a delivered portion; and
measuring the delivered portion of the energy to produce a measured amount of energy;
wherein distributing a portion of the benefit to the host community member includes directing a reconciliation benefit to the host community member, the reconciliation benefit being based on the difference between the measured amount of energy and the expected generation value.

7. The method of claim 1, wherein distributing a portion of the benefit to the community interest includes directing a portion of the benefit directly to the community interest.

8. The method of claim 7, wherein distributing a portion of the benefit to the community interest includes directing a portion of the benefit to a separate receiver entity.

9. The method of claim 1, wherein distributing a portion of the benefit to the community interest includes directing a community portion of the benefit to the host community member prior to the community portion of the benefit being directed to the community interest.

10. The method of claim 1, further comprising receiving one or more periodic payments from the host community member, the magnitude of the periodic payment being based on the amount of energy actually produced or expected to be generated by the energy generating equipment within a corresponding period;
wherein distributing the benefit to the community interest includes distributing at least a portion of one of the periodic payments to the community interest.

11. The method of claim 1, wherein:
estimating the benefit rate includes defining a periodic payment based on the energy actually produced or on a prorated estimate of the energy that will be generated over the lifetime of the energy generating equipment; and
distributing the benefit to the community interest includes distributing at least a portion of the periodic payment to the community interest.

12. A method of allocating benefits received in response to generating energy within a community to a community interest, comprising:
deploying energy generating equipment on property of a host community member,
receiving one or more periodic payments from the host community member, the periodic payment defined by an amount of energy actually produced or by the amount of energy expected to be generated by the energy generating equipment during a corresponding period; and
distributing at least a portion of one of the periodic payments to the community interest.

13. The method of claim 12, further comprising:
delivering a portion of the energy generated by the energy generating equipment to the host community member, a receiving community member, or a power grid to define a delivered portion;
measuring the delivered portion of the energy to define a measured amount of energy; and
adjusting the periodic payment to reflect the difference between the amount of energy expected to be generated by the energy generating equipment during the corresponding period and the measured amount of energy.

14. The method of claim 12, further comprising:
delivering a portion of the energy generated by the energy generating equipment to the host community member, a receiving community member, or a power grid to define a delivered portion;
measuring the delivered portion of the energy to define a measured amount of energy; and
providing the host community member with a reconciliation payment, the reconciliation payment reflecting the difference between the amount of energy expected to be generated by the energy generating equipment during the corresponding period and the measured amount of energy.

15. The method of claim 12, further comprising:
delivering a portion of the energy generated by the energy generating equipment to the host community member, a receiving community member, or a power grid to define a delivered portion;
measuring the delivered portion of the energy to define a measured amount of energy; and
wherein the portion of one of the periodic payments distributed to the community interest reflects an excess amount of energy generated by the energy generating equipment during the corresponding period compared to the amount of energy expected to be generated by the energy generating equipment during the corresponding period.

16. The method of claim 12, wherein each of the one or more periodic payments from the host community member are made pursuant to a lease agreement covering the energy generating equipment.

17. The method of claim 16, wherein distributing the at least a portion of one of the periodic payments to the community interest includes distributing a portion of the periodic payment directly from the host community member to the community interest.

18. The method of claim 12, wherein each of the one or more periodic payments from the host community member are made pursuant to a power purchase agreement.

19. A method for displaying information related to energy generated by a community with energy generating equipment installed on property of members of the community, comprising:
storing into non-volatile memory cost parameters specifying the value of energy produced by the energy generating equipment;
storing into non-volatile memory a measured amount of energy produced by the energy generating equipment;
determining the value of energy produced by the energy generating equipment by executing, with a microprocessor, computer executable instructions to compare the cost parameters with the measured amount of energy generated; and
displaying, with a microprocessor, one or more of the measured amount of energy produced and the value of the energy produced.

20. The method of claim 19, wherein the cost parameters change dynamically and storing the cost parameters into non-volatile memory includes dynamically updating the cost parameters in the non-volatile memory.

21. The method of claim 19, wherein storing into non-volatile memory a measured amount of energy produced by the energy generating equipment includes storing a plurality of measured amounts of energy produced by energy generating equipment installed on the property of a plurality of members of the community, respectively.
